(19) United States
(12) Patent Application Publication
(10) Pub. No.: US 2025/0317304 A1
(43) Pub. Date: Oct. 9, 2025

(54) EVENTUALLY GUARANTEED PROTOCOL FOR DISTRIBUTED LEDGER

(71) Applicants: Yeda Research and Development Co. Ltd., Rehovot (IL); Technion Research & Development Foundation Limited, Haifa (IL)

(72) Inventors: Ehud Y. SHAPIRO, Nataf (IL); Idit KEIDAR, Haifa (IL); Oded NAOR, Haifa (IL)

(73) Assignees: Yeda Research and Development Co. Ltd., Rehovot (IL); Technion Research & Development Foundation Limited, Haifa (IL)

(21) Appl. No.: 18/864,530

(22) PCT Filed: May 10, 2023
(86) PCT No.: PCT/IL2023/050484

§ 371 Date: Nov. 10, 2024

Related U.S. Application Data
(60) Provisional application No. 63/340,047, filed on May 10, 2022.
(60) Provisional application No. 63/343,656, filed on May 19, 2022.
(60) Provisional application No. 63/393,935, filed on Jul. 31, 2022.
(60) Provisional application No. 63/418,573, filed on Oct. 23, 2022.

(51) Int. Cl. H04L 9/32

(52) U.S. Cl. CPC H04L 9/3247; H04L 9/3236

(57) ABSTRACT

A system and a method for efficient, safe, and eventually guaranteed block registration on distributed ledgers, using a protocol family named Cordial Miners is disclosed. The disclosure comprises three exemplary embodiments of a distributed ledger block registration protocol. The disclosed protocol may be used as a blockchain consensus protocols that shares a partially-ordered data structure and an ordering algorithm. The data structure may be a generalization of the totally-ordered blockchain, and referred to as blocklace. The ordering algorithm may convert the partially-ordered blocklace into a totally-ordered sequence of blocks, while excluding non-valid blocks such as equivocations.

### RELATED APPLICATION/S

This application claims the benefit of priority of U.S. Provisional Patent Application No. 63/340,047 filed on 10 May 2022, No. 63/343,656 filed on 19 May 2022, No. 63/393,935 filed on 31 Jul. 2022 and No. 63/418,573 filed on 23 Oct. 2022, the contents of which are incorporated herein by reference in their entirety.

### BACKGROUND

The present invention, in some embodiments thereof, relates to distributed computing, and, more particularly, but not exclusively, efficient, safe, and eventually guaranteed block registration on distributed ledgers.

The problem of reaching consensus on the ordering of acts by participants in a distributed system has been investigated for four decades, with recent focus on two aspects: Permissioned, where the set of participants is predetermined by an outside authority, and permissionless, where anyone may join and participate provided that they pass some ‘sybil-proof’ test, notably proof-of-work, or proof-of-stake. In the permissioned category, methods such as the State-Machine-Replication protocol (SMR) which is a consensus on an ordering of proposals, may be used for the eventual-synchrony model. Additionally, Hotstuff and the Byzantine Atomic Broadcast protocol (BAB) based on consensus on an ordering of all proposals made by correct participants, may also be used for the eventual-synchrony model. For the asynchronous model, DAG-Rider may be used. Since the emergence of cryptocurrency, such as Bitcoin and Ethereum, with its support for smart contracts, permissionless consensus protocols have been proposed. Methods such as stake-based sampling, have allowed permissioned consensus protocols to be used for cryptocurrency, offering improved efficiency and throughput compared to proof-of-work protocols. According to stake-based sampling, in every epoch, a time range which could be measured in minutes or weeks, a new set of miners is chosen in a random auction, where the probability of being a winner is correlated with the stake bid by the miner. Mechanism design of methods such as stake-based sampling ensure that miners benefit from performing the protocol well, benefit less if they perform the protocol less well, and lose their stake if they subvert the protocol. Therefore, the expectation is that miners will do their best, not their worst, to execute the protocol, and hence the focus of analyses of permissioned consensus protocols has shifted from worst-case complexity to assumptions such as good-case complexity, where miners are generally expected to behave as well as possible, given compute and network limitations. However, protections against a malicious adversary are still needed, for example to prevent a double-spending, a hostile takeover, or a meltdown of a cryptocurrency supported by the consensus protocol.

The use of a DAG-like structure to solve consensus has been introduced in previous works, such as in asynchronous networks. Hashgraph introduced an unstructured DAG, with each block containing two references to previous blocks, and on top of the DAG the miners run an inefficient binary agreement protocol, leading to high time complexity. Aleph introduced a structured round-based DAG, where miners proceed to the next round once they receive 2f+1 DAG nodes from other miners in the same round. On top of the DAG protocols Aleph comprises a binary agreement protocol to decide on the order of vertices to commit. Nodes in the DAG are assumed to reliably broadcast.

DAG-Rider is also based on a structured round-based DAG protocol that proceeds in rounds. Nodes are also assumed to have reliable broadcast capability. The DAG is divided to waves, each consisting of the nodes of four rounds. When a wave ends, miners locally check whether a decision rule is met, and output the blocks accordingly. Bullshark is a dual consensus protocol based on DAG-Rider that offers a fast-track to commit nodes every two rounds in case the network is synchronous.

Other DAG-based consensus protocols include HotStuff, which has a commit rule based on a final leader. The commit rule is met when there are three consecutive correct leaders in a row. HotStuff is based on Tendermint. HotStuff may not guarantee fairness or liveness, i.e. that each block properly proposed by a miner is eventually guaranteed to be included in the blockchain. HotStuff works in eventually synchronous networks and is a leader-based consensus protocol.

The blocklace was introduced in reference Ehud Shapiro. 2021. Multiagent Transition Systems: Protocol-Stack Mathematics for Distributed Computing, on Arxiv. For completeness the needed definitions and results are included, for more details relegate to Multiagent Transition Systems: Protocol-Stack Mathematics for Distributed Computing which is hereby incorporated by reference. Blocklace utilities that realize intra alia these definition are presented in FIG. 9.

### SUMMARY

It is an object of the present invention to provide a system and a method for block registration using a partially ordered data structure, and a distributed consensus protocol, based on miners' cordiality and a deterministic iterative ordering function.

According to an aspect of some embodiments of the present invention there is provided a system configured for block registration using a partially ordered data structure, and a distributed consensus protocol for communicating with a first number of computing nodes through a network, the system comprising:
at least one processing circuitry configured to:
   accumulate a plurality of cryptographically signed blocks from a plurality of computing nodes from the first number of computing nodes, each block from the plurality of cryptographically signed blocks comprising a set of pointers to an additional block;
   when each of the additional blocks to which a cryptographic hash pointer from the set of cryptographic hash pointers of each cryptographically signed block of the plurality of cryptographically signed blocks points, is accumulated or exists in the partially ordered data structure, add the cryptographically signed block to the partially ordered data structure; and
   when a block generated by a designated computing node becomes finalized, starting with the block as the first block, to place in order, in an iterative or recursive manner, with most recent former block generated by the designated computing node of associated round and having an associated cryptographic hash pointer in the set of cryptographic hash pointers of a second number of blocks of a round following the associated round, acting as the second block and the first block for a next iteration, until the first block is in a fully ordered data structure, by adding each block reachable by a cryptographic hash pointer or iteratively following a set of cryptographic hash pointers of a block reachable by the cryptographic hash pointer, the cryptographic hash pointer existing in the set of cryptographic hash pointers of the first block but not in the set of cryptographic hash pointers of the second block, ordered by a deterministic topological-sorting method common to the first number of computing nodes, and prepended by the blocks produced by the next iteration, to the fully ordered data structure.

According to an aspect of some embodiments of the present invention there is provided a method for block registration using a partially ordered data structure, and a distributed consensus protocol for communicating with a first number of computing nodes through a network, the method comprising:
accumulate a plurality of cryptographically signed blocks from a plurality of computing nodes from the first number of computing nodes, each block from the plurality of cryptographically signed blocks comprising a set of pointers to an additional block;
when each of the additional blocks to which a cryptographic hash pointer from the set of cryptographic hash pointers of each cryptographically signed block of the plurality of cryptographically signed blocks points, is accumulated or exists in the partially ordered data structure, add the cryptographically signed block to the partially ordered data structure; and
when a block generated by a designated computing node becomes finalized, starting with the block as the first block, to place in order, in an iterative or recursive manner, with most recent former block generated by the designated computing node of associated round and having an associated cryptographic hash pointer in the set of cryptographic hash pointers of a second number of blocks of a round following the associated round, acting as the second block and the first block for a next iteration, until the first block is in a fully ordered data structure, by adding each block reachable by a cryptographic hash pointer or iteratively following a set of cryptographic hash pointers of a block reachable by the cryptographic hash pointer, the cryptographic hash pointer existing in the set of cryptographic hash pointers of the first block but not in the set of cryptographic hash pointers of the second block, ordered by a deterministic topological-sorting method common to the first number of computing nodes, and prepended by the blocks produced by the next iteration, to the fully ordered data structure.

According to an aspect of some embodiments of the present invention there is provided a method for distributed consensus ordered block registration using a partially ordered data structure, and communicating with a first number of computing nodes through a network, the method comprising:
accumulate a plurality of cryptographically signed blocks from a plurality of computing nodes from the first number of computing nodes, each block from the plurality of cryptographically signed blocks comprising a set of cryptographic hash pointers, each cryptographic hash pointer pointing to an additional block;
execute a protocol adapted to synchrony specifications of the network on the plurality of cryptographically signed blocks using the network; and
generate a consecutive cryptographically signed block while adding to the block the set of cryptographic hash pointers, so that a path based on the set of cryptographic hash pointers exists to each of the plurality of cryptographically signed blocks.

According to an aspect of some embodiments of the present invention there is provided a system configured for distributed consensus ordered block registration using a partially ordered data structure, and communicating with a first number of computing nodes through a network, the system comprising:
at least one processing circuitry configured to:
   accumulate a plurality of cryptographically signed blocks from a plurality of computing nodes from the first number of computing nodes, each block from the plurality of cryptographically signed blocks comprising a set of cryptographic hash pointers, each cryptographic hash pointer pointing to an additional block;
   execute a protocol adapted to synchrony specifications of the network on the plurality of cryptographically signed blocks using the network; and
   generate a consecutive cryptographically signed block while adding to the block the set of cryptographic hash pointers, so that a path based on the set of cryptographic hash pointers exists to each of the plurality of cryptographically signed blocks.

Optionally, the set of cryptographic hash pointers added to the consecutive cryptographically signed block is generated while prioritizing sources having no cryptographic hash pointer pointing to in the set of cryptographic hash pointers comprised by other blocks.

Optionally, the processing circuitry is further configured to store a block from the plurality of cryptographically signed blocks in a buffer when at least one cryptographic hash pointer from the set of cryptographic hash pointers pointing to at least one unknown block.

Optionally, the processing circuitry is further configured to move the block from the buffer to the partially ordered data structure when the at least one unknown block is accumulated.

Optionally, a block is indicated unknown to at least one of the number of computing nodes until either the block or a block comprising at least one cryptographic hash pointer from the set of cryptographic hash pointers pointing the block is received from the at least one of the number of computing nodes, or the block is sent to the at least one of the number of computing nodes.

Optionally, further comprising maintaining a communication history data structure for storing pointers of cryptographically signed blocks received from each of the first number of computing nodes, and a cryptographically signed blocks is indicated unknown to at least one of the first number of computing nodes according to the communication history data structure.

Optionally, the protocol adapted to synchrony specifications of the network comprising when a block from the plurality of cryptographically signed blocks is indicated unknown to at least one of the first number of computing nodes, send the block to a designated computing node.

Optionally, generating a consecutive cryptographically signed block further comprising verifying that the plurality of cryptographically signed blocks comprising blocks of preceding round from at least a second number of computing nodes; and the protocol adapted to synchrony specifications of the network further comprising:
send the consecutive cryptographically signed block to each of the first number of computing nodes which meets a functionality requirement; and
when the at least one processing circuitry implementing the designated computing node, when blocks of the preceding round are received from each of the at least a second number of computing nodes, and the at least one of the first number of computing nodes meets the functionality requirement, send the blocks indicated unknown to at least one of the first number of computing nodes to the at least one of the first number of computing nodes.

Optionally, the protocol adapted to synchrony specifications of the network further comprising when the at least one processing circuitry implementing the designated computing node:
generating a consecutive cryptographically signed block further comprising verifying that the plurality of cryptographically signed blocks comprising blocks of preceding round from at least a second number of computing nodes; and
when a block from the plurality of cryptographically signed blocks is indicated unknown to at least one of the first number of computing nodes, and the at least one of the first number of computing nodes meets a functionality requirement, send the block to the at least one of the first number of computing nodes.

Optionally, generating a consecutive cryptographically signed block further comprising verifying that the plurality of cryptographically signed blocks comprising blocks of preceding round from at least a second number of computing nodes; and the protocol adapted to synchrony specifications of the network further comprising:
send the consecutive cryptographically signed block to each of the first number of computing nodes which meets a functionality requirement; and
when the at least one processing circuitry implementing the designated computing node, when blocks of the round preceding by a predetermined number, are received from each of the at least a second number of computing nodes, and the at least one of the first number of computing nodes meets the functionality requirement, send the blocks indicated unknown to at least one of the first number of computing nodes to the at least one of the first number of computing nodes.

Optionally, the designated computing node is designated by a method selected from the group consisting of round robin, a predetermined pseudorandom series, and a global perfect coin.

Optionally, a block becomes finalized when the block was generated by a designated node of a round, and at least the second number of the blocks of a second following round, comprising the block generated by the designated computing node of the second following round, have in each of a second associated set of cryptographic hash pointers, at least the second number of pointers pointing each to a block from a first following cycle, each have in a first associated set of cryptographic hash pointers, a cryptographic hash pointer pointing to the block, and the cryptographic hash pointer pointing to the block is the only cryptographic hash pointer, in the first associated set of cryptographic hash pointers, pointing to a block generated by the designated node of the round at the round.

Optionally, at least a second number is over two thirds of the first number.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for block registration on distributed ledgers, according to some embodiments of the present invention;

FIG. 2 is a schematic diagram of an exemplary system for block registration on distributed ledgers, according to some embodiments of the present invention;

FIG. 3 is a basic flow chart of a first exemplary process for block registration on distributed ledgers, according to some embodiments of the present invention;

FIG. 4 is a basic flow chart of a second exemplary process for block registration on distributed ledgers, according to some embodiments of the present invention;

FIG. 5A is an exemplary illustration of a partially ordered data structure, according to some embodiments of the present invention;

FIG. 5B, is an exemplary illustration of equivocations, approval and ratification in a partially ordered data structure, according to some embodiments of the present invention;

FIG. 6 is a set of diagrams illustrating exemplary causal relations of blocks, according to some embodiments of the present invention;

FIG. 7 is a set of diagrams illustrating exemplary finalizations of blocks, according to some embodiments of the present invention;

FIG. 8 is a table of exemplary protocols adapted to synchrony specifications of the network, according to some embodiments of the present invention;

FIG. 9 is an exemplary pseudocode of utility functions related to a partially ordered data structure, according to some embodiments of the present invention;

FIG. 10 is an exemplary pseudocode of a function for adding blocks from a partially ordered data structure to a fully ordered data structure, according to some embodiments of the present invention;

FIG. 11A is an exemplary pseudocode of a protocols adapted to synchrony specifications of the network, according to some embodiments of the present invention;

FIG. 11B, is an alternative exemplary pseudocode of a protocols adapted to synchrony specifications of the network, according to some embodiments of the present invention.

FIG. 12 is another exemplary pseudocode of a protocols adapted to synchrony specifications of the network, according to some embodiments of the present invention; and

FIG. 13 is an additional exemplary pseudocode of a protocols adapted to synchrony specifications of the network, according to some embodiments of the present invention.

### SPECIFIC EMBODIMENTS OF THE INVENTION

The present invention, in some embodiments thereof, relates to distributed computing, and, more particularly, but not exclusively, efficient, safe, and eventually guaranteed block registration on distributed ledgers.

The disclosure comprises three exemplary embodiments of a distributed ledger block registration protocol, which may be referred to as a Cordial Miners. The disclosed protocol may be used as a blockchain consensus protocols that shares a data structure and an ordering algorithm. The data structure may be a partially-ordered generalization of the totally-ordered blockchain, and referred to as blocklace. The ordering algorithm may convert the partially-ordered blocklace into a totally-ordered sequence of blocks, while excluding non-valid blocks such as equivocations. The conversion process may be monotonic in that the output sequence only extends as the input blocklace increases, and in this sense any prefix of the output sequence may be final.

Some embodiments of the present disclosure comprise concepts applied by the protocol DAG-Rider, a Byzantine Atomic Broadcast protocol. Some embodiments of the present disclosure comprise concepts applied by Hotstuff, a State-Machine Replication protocol. Concepts applied by HotStuff may be used when the network is consistent with the eventual synchrony model, and concepts applied by DAG-Rider when the network is consistent with the eventual asynchrony model. Furthermore, a hybrid protocol that integrates concepts applied by DAG-Rider and concepts applied by HotStuff is disclosed.

The exemplary protocols disclosed, also referred to as Cordial Miners protocols, and may be simpler than DAG-Rider and HotStuff in several aspects while maintaining efficiency. Simplicity of the Cordial Miners protocols may stem from using a partially ordered data structure, namely the blocklace, for all key algorithmic tasks, including data dissemination, equivocation exclusion, leader commitment, and ordering, and for the identification and exclusion of non-cordial miners, such as nonresponsive and equivocating miners. The protocols may differ in communication patterns: all-to-all in the asynchronous; all-to-leader-to-all with timeout in the synchronous; and all-to-all with leader-based backlog dissemination in the hybrid protocol.

The protocol may be used in a network wherein miner may generate blocks and send them to other miners. Optionally, the miner generates the payload (transactions/acts) in a block. Alternatively, the payload may include transactions received from users of the system, wherein each user may be connected to one or more miners. As used herein, the term node may refer to miners and users, miners may be referred to as miner nodes, and similarly, users as user nodes.

As used herein, the term ‘Blocklace’ refers to a shared data structure which may be a partially-ordered generalization of the totally-ordered blockchain, that comprises cryptographically-signed blocks, each containing a payload and a finite number of pointers, which may be cryptographic hashed, pointing to previous blocks. The blocklace may comprise a DAG, as cryptographic hash pointers in some embodiments are guaranteed not to form cycles by a compute-bound adversary. The DAG induces a partial order operator, marked ‘>’ on the blocks that includes Lamport's ‘happened-before’ causality relation, i.e. that there is a directed, immediate or mediated, connection through the DAG edges from the DAG vertices associated with the blocks. The globally-shared blocklace may be constructed incrementally and cooperatively by all miners, and the miners may disseminate the blocklace or parts thereof to other miners.

As used herein, the term ‘Ordering with Super-Ratified Leaders’ refers to an ordering algorithm which may be implemented and used locally by each miner to convert a locally-known part of the blocklace into a totally-ordered output sequence of blocks, while excluding non-valid blocks such as excluding equivocation along the way.

The conversion may be monotonic, so that the output sequence may be extended as the miner receives or generates blocks, and/or portions of the global blocklace, and in this sense every output block of each miner may be final.

As used herein, two sequences are considered consistent if one is a prefix of the other. When less than one third of the miners are faulty or compromised, the correctness of the Cordial Miners protocols it may be shown that the outputs of different miners are consistent, and a valid block known to a correct miner will be eventually output by every correct miner. The simplicity of the protocols in the Cordial Miners family stems from their use of the blocklace and its analysis for all key algorithmic tasks.

Several functions of correct miners are described as follows: As used herein, the term ‘Dissemination’ refers informing other miners of blocks generated or received according to the following policy. When a new block created by a miner p, the miner p may acknowledge blocks known to p by including pointers to the tips, which may be referred to as DAG sources, of p's local blocklace, including p's previous block. Correspondingly, a miner p may buffer, rather than include in its blocklace, any received block with dangling pointers, i.e. when at least one of the pointers points to a block not known to p. Hence, a block b by p informs any recipient q of blocks not known to p at the time of b's creation. Thus q, being cordial, when sending p a new q-block, may include with it blocks generated or received by q but, as indicated to q, were not received by p and have not already been sent to p, thus providing block dissemination.

As used herein, the term ‘Equivocation’ refers to a pair of blocks by the same miner that are not causally related, i.e. have no path of pointers from one to the other; such blocks are conflicting and a miner that creates them is an equivocator. The shared blocklace may eventually include any conflicting block known to a correct miner, and hence eventually known to all correct miners. It is an object of the disclosure to describe how miners may mitigate equivocations.

As used herein, the term acknowledge refers to the following: A block b acknowledges block b′ if there is a path from b to b′. A trivial, empty path, also counts as acknowledgement, thus it may be marked b≥b′. The notation [b] denotes the set of blocks acknowledged by b, and may also be referred to as the closure of b.

As used herein, the term approve refers to the following: A block b approves block b′ if it acknowledges b′ and does not acknowledge any block b″ conflicting with b′, i.e. a block from the same miner without causal relation to b′. A miner may not approve both blocks of an equivocation without being itself an equivocator. Hence, if less than one-third of the miners are equivocators, then no equivocation will ever receive an approval from blocks created by a supermajority.

As used herein the term supermajority, which may also be referred to as a second number of computing nodes, may refer to different numbers, for example 60% of the miner nodes, or 80% thereof, however a number over two-thirds of the miners may be shown to guarantee the correctness of the output.

Safety refers to that the outputs of every two correct, non-faulty, computing nodes, which may function as agents are consistent.

Liveness refers to that every block produced by a correct agent will eventually be output by every correct agent with probability 1.

When the number of faulty computing nodes is less than f out of n computing nodes, the safety property may be shown to be guaranteed when the supermajority is at least (n+f)/2. The liveness property may be shown to be guaranteed if, in addition, f<⅓n, however future variants of the disclosure may require different thresholds, and higher thresholds may be used in some implementations. The equivocation-exclusion may be enabled by the blocklace as follows: A miner may finalize a block b once the miner's local blocklace comprises blocks that approve b by a supermajority.

As used herein, the term ‘depth’ of a block b refers to the maximal length of any path emanating therefrom.

As used herein, the term ‘round’, refers to a set of blocks of the same depth.

As used herein, the term ‘Cordial Miners’ refers to miners which maintain the following properties: First, as explained in disseminating blocks to other miners when the other miners may not have received the blocks. Second, in waiting for a supermajority of round d before producing a block of round d+1.

The term Cordial may also apply to blocks. When two blocks of a blocklace b′, b∈B are two consecutive p-blocks. Block b may be considered cordial if [b]\([b′]∪{b}) is a supermajority, or if at least a second number of the blocks of the most recent round are acknowledged by b. Miner p may be considered cordial in blocklace B⊆B if every p-block b∈B is cordial.

In a blocklace B⊆B, a round r≥1 in B refers to the set of blocks {b∈B: depth(b)=r}. A designated node, also referred to as a leader may be chosen by a selection function: N [symbol] Π. If leader(r)=p then p is a designated node, or leader of round r, and if, in addition, b∈B is a p-block of depth r, then b is a block from the designated node of the round, or a leader block of round r in B. When b′, b∈B are two consecutive p-blocks, the block b may be referred to as cordial if [b]\([b′]∪{b}) is a supermajority, or above the second number. Miner p is cordial in blocklace B⊆B if every p-block b∈B is cordial. Furthermore, in a blocklace B⊆B, a round c≥1 in B refer to the set of blocks of the depth r, {b∈B: depth(b)=r}. When p is the leader of a round r, leader(r)=p, and if, in addition, b∈B which is a p-block of depth r, the block b may be referred to as a leader block of round r in B.

As used herein, the term Leaders, refers to a designated node, or a miner, which may change every round It should be noted that random sequences, as well as variants may keep a leader for some consecutive rounds deterministically or in some probability, for example 3 or 12 rounds, and are within the scope of the claims. In some implementations, the designated computing node may be designated by a round robin. In some other implementations, the designated computing node may be chosen according to a predetermined pseudorandom series. In some other implementations, the designated computing node may be chosen during one of the following rounds by a global perfect coin, which is a method for a distributed agreed random sequence that may not be known in advance. Variants of methods for choosing a designated node, fair and weighted, are apparent to the person skilled in the art, and within the scope of the claims.

A block b may be considered ratified by block b′ when [b′] includes a blocks from a supermajority of miners that approves b in a following round.

A leader block b of depth r may be considered super-ratified when there is leader block b′ of depth greater than r by a number, for example r+3 such that [b′] includes a second supermajority of blocks from that round from a supermajority of nodes B′, each member of the second supermajority acknowledges the first supermajority B that approves b. It should be noted that not every block from the second supermajority has to acknowledge the same blocks, however cryptographic hash pointers to a first supermajority B that approves b are required for each of the second supermajority. Additional condition for block super ratification may require that the second supermajority comprising the block generated by the designated computing node of the round.

A given deterministic procedure for ordering blocks that respects their causal partial order, may be noted by ‘>’, for example, lexicographic ordering of elements unrelated by > is disclosed. Ordering by leaders may be implemented using a recursive ordering function, noted tau, or τ, applied to a leader block b, which may be defined as follows: Apply the block b′, which is the highest-depth leader block in [b] ratified by b. When there is no such block b′, output the lexicographic ordering of [b] and terminate. When there is such block b′, recursively call the ordering function with b′ and output its result following by the lexicographic ordering of [b]\[b′].

The finality by the super-ratified leaders may be shown: An exemplary supermajority of more than two thirds of the computing nodes, also referred to as miners may be shown, to guarantee the super-ratified leader is ratified by subsequent leaders. Hence, the ordering algorithm which may be used by miners is as follows: When identifying a new super-ratified leader b in its blocklace, apply the ordering function t to b and output the newly added suffix since the previous super-ratified leader. As the ordering function may be shown to guarantee selecting the previous super-ratified leader in one of its recursive calls, it may be optimized to return if it does so, rather than re-compute the prefix it has already delivered.

The methods of the disclosure may also comprise identification and exclusion of faulty miners: Since a faulty p-block known to some correct miners will eventually be known to all, correct miners may suspend further communication with p. For example, a miner may verify whether another miner p is cordial in the second sense, i.e. waiting for a supermajority of round d before producing a block of round d+1, by examining the blocklace. In addition, an equivocation by p, with each block of the pair known to a different correct miner, will eventually be known to all and may result in the exclusion of p.

The methods of the disclosure may also comprise exclusion of nonresponsive miners: A cordial miner may ignore nonresponsive miners. A miner p may suspend sending new blocks to a miner q as long as q has not acknowledged a previous block b sent to q by p. If q fail-stopped, then p may not waste resources on q; if q is only suspended or delayed, then eventually q may send to p a block acknowledging b, following which p, being cordial, may send to q all the backlog p has previously refrained from sending it, and is not acknowledged by the new block received from q. Miners may accomplish all the above by simple and efficient analysis of their local blocklace.

For the purpose of Safety and Liveness property analysis it may be assumed that n≥3 miners, also referred to as Π, are present. The set of miners may also be referred to as the first number of computing nodes, of which f<n/3 may be faulty or compromised, and may behave arbitrarily, which may also be referred to as Byzantine. It is also assumed that the rest are correct, and that a message sent from one correct miner to another will eventually arrive. It's also assumed that every miner has a single and unique key-pair (PKI) and can cryptographically sign messages. Each miner p∈Π may receive an input, which may arrive from a plurality of unique or non-unique user processes, and may be referred to as payload. The payload property or function may return a payload, for example a proposal from a user or a mempool, and an output call deliver(b) wherein b is a block.

A Prefix, marked [symbol] , may be used to indicate when two sequences are Consistent Sequences. A sequence x may be considered a prefix of a sequence x′, x [symbol] x′ if x′ can be obtained from x by appending to it zero or more elements. Two sequences x, x′ are consistent if x [symbol] x′ or x′ [symbol] x.

Safety and Liveness are the requirements of correct miners of a blocklace-based Byzantine Atomic Broadcast protocol: Safety refers to that outputs of miners are consistent. The liveness property, which refers to the certainty that a block created by a correct miner is eventually output by every miner, may also be referred to as fairness. These safety and liveness requirements, combined with the uniqueness of a block in a blocklace, imply the standard Byzantine Atomic Broadcast guarantees: Agreement, Integrity, Validity, and Total Order.

The safety and liveness of the two protocols may be indicated, assuming less than one third of the computing nodes or miners are faulty, and referring to the remaining correct miners. The function τ converts a blocklace to a sequence of blocks is monotonic with respect to the superset relation in that its output sequence is extended as its input blocklace grows. Note that if two sequences are each a prefix of a third sequence, then they are consistent, and for two local blocklaces B, B′ of miners p, p′, then due to the monotonicity of τ, both τ(B) and τ(B′) are prefixes of τ(B∪B′). Therefore they are consistent, and hence safety is guaranteed.

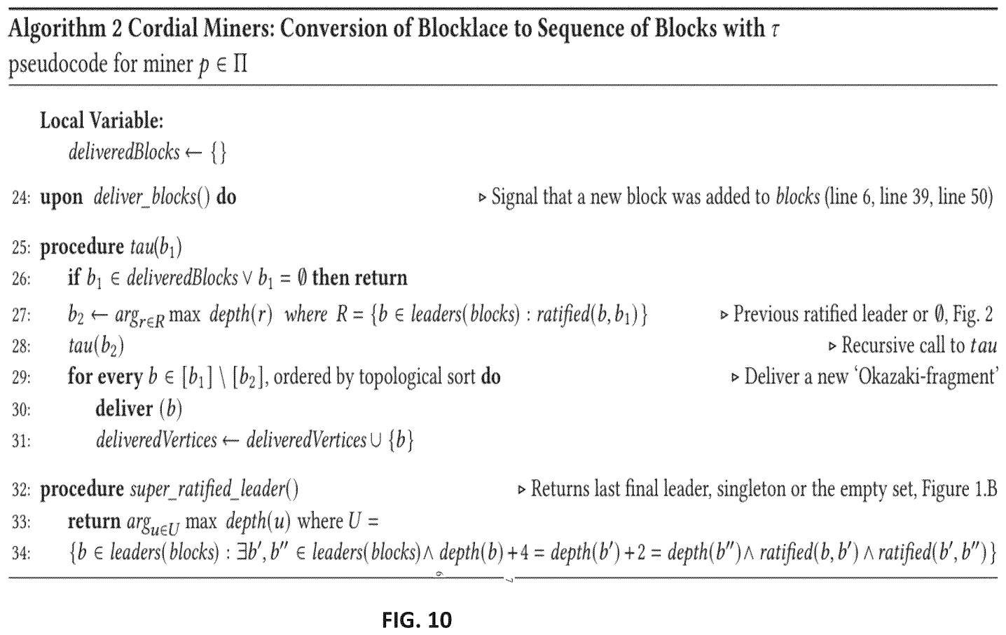

It may be shown that the method of Algorithm 2, shown in FIG. 10 correctly implements τ and hence satisfies safety. The Liveness: may be shown for the proposed protocols adapted to synchrony specifications of the network, which are different however share a structure since the conversion function τ, applied to a final leader block b, includes in the output sequence all the block known to the final leader, namely all blocks in [b].

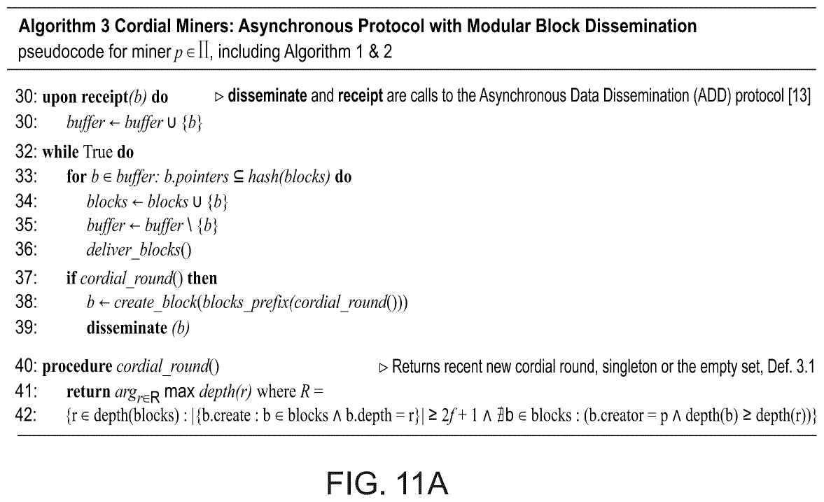

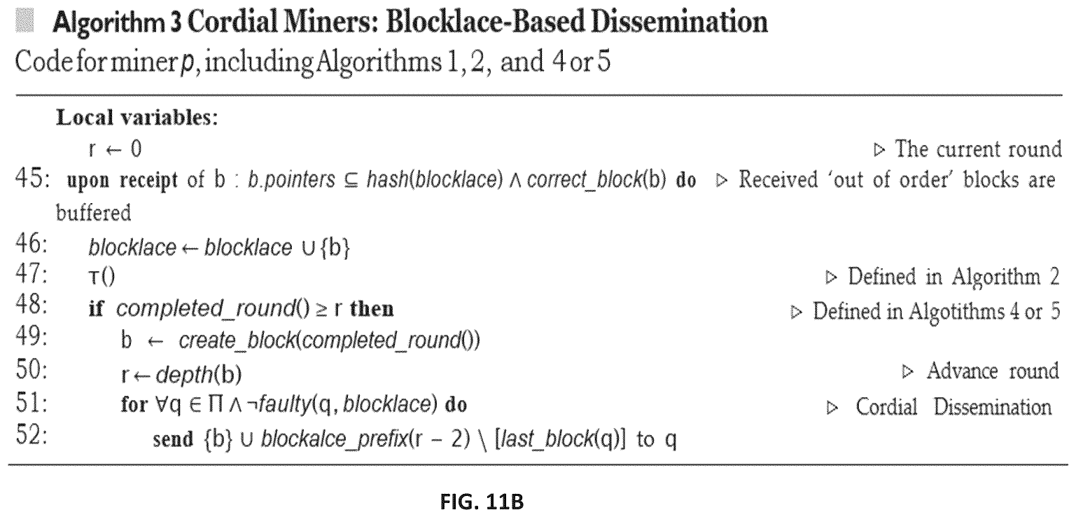

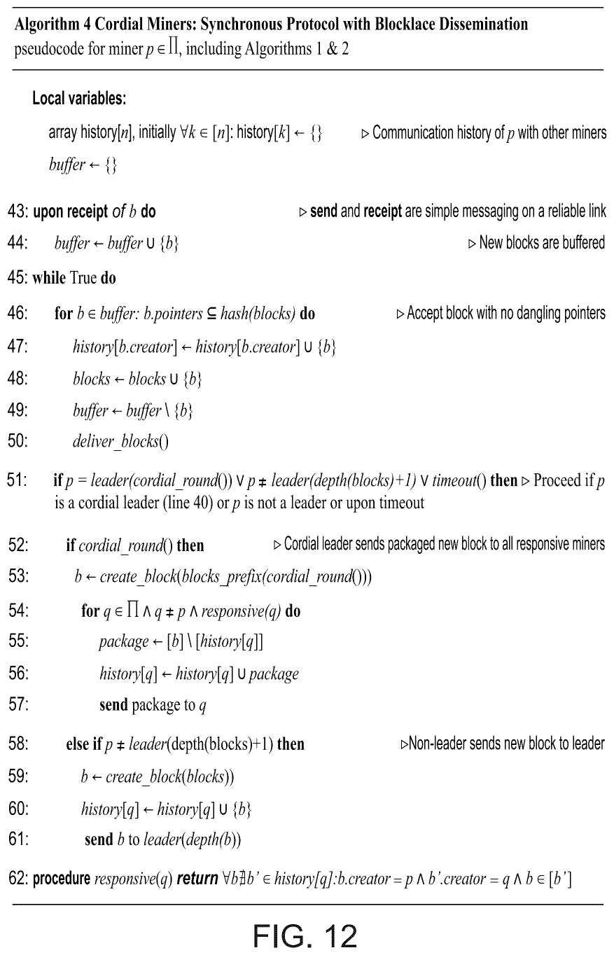

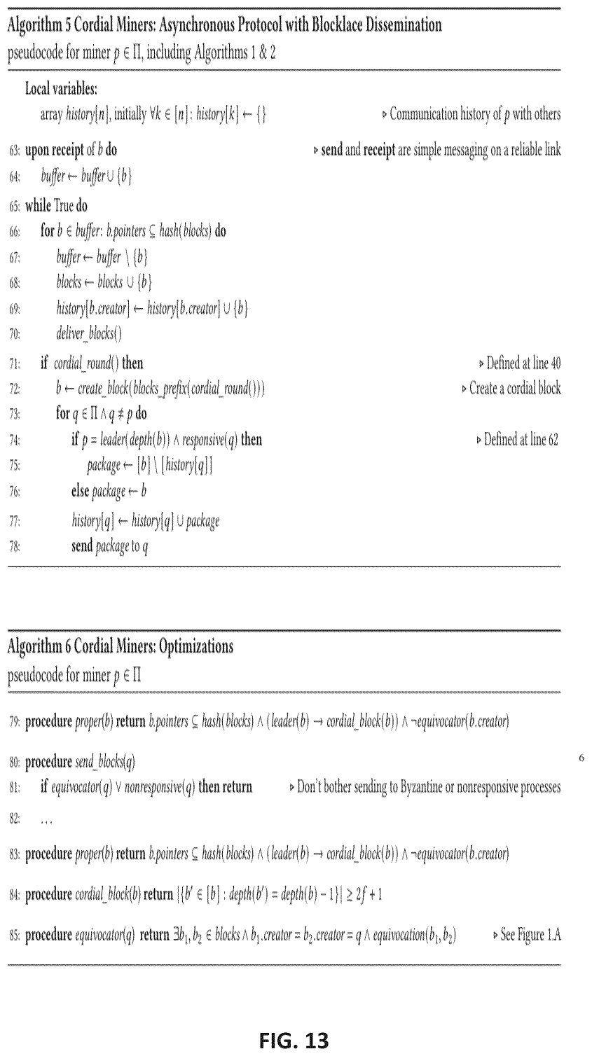

Additionally, given a block b, known to a correct miner at some point t in the computation, b will eventually be known to every correct miner at some later point t′ in the computation. The eventual block propagation follows from the correctness of the underlying asynchronous data dissemination protocol used, for example, by Algorithm 3 as in FIG. 11A. For the two other exemplary algorithms, Algorithm 4 as in FIG. 12, and Algorithm 5 as in FIG. 13, it may be shown that eventually some leader block b′ of a miner will be ratified at a point later than t′ with probability 1. Followingly, since, b∈[b′], b is included in the output of t applied to b′.

In the Synchronous Cordial Miners protocols, such as Algorithm 4 as in FIG. 12, every block in the blocklace is sent from the miner that creates it to the leader. In the worst-case, there may be a linear number of Byzantine leaders in a row, meaning at most that each block has to be sent O(n²) times. The block size is linear, due to its hash pointers, meaning a bit complexity of O(n³) per block. The leader sends to all miners the blocks it receives, i.e., it sends a linear number of blocks, each linear in size, resulting in a bit complexity of O(n³) as well. However, batching per block a linear number of transactions, when the commit rule is met a quadratic number of transactions is committed each time. Thus, the amortized bit complexity per decision is O(n).

HotStuff also achieves this complexity in the good-case, i.e., when all miners are synchronized to the same round. For the Asynchronous Cordial Miners protocol, each block may be disseminated using an O(n²) message complexity dissemination protocol. Since each block is linear-sized, the bit complexity of the dissemination each node may be O(n³). In a similar way to the synchronous protocol, each block can also be batched with a linear number of transactions. Thus, when the commit rule is met, a quadratic number of transactions may be committed, leading to an amortized O(n) bit complexity per decision as well. This is the same amortized bit complexity as DAG-Rider.

The disclosed Cordial Miners protocol family may be simple. It should be noted that variants are apparent to the person skilled in the art and are within the scope of the claims. Simpler algorithms may be easier to debug, to optimize, enable robustness, and extendibility. The Cordial Miners protocol family may be executed together with a mechanism aimed to reward miners' cooperation, as opposed to competition, which is the ubiquitous among cryptocurrencies.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

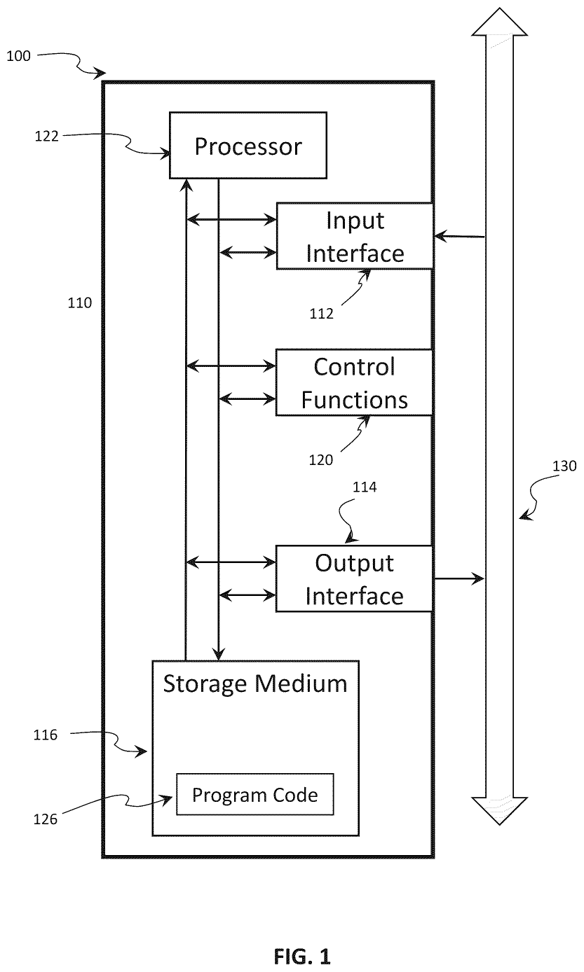

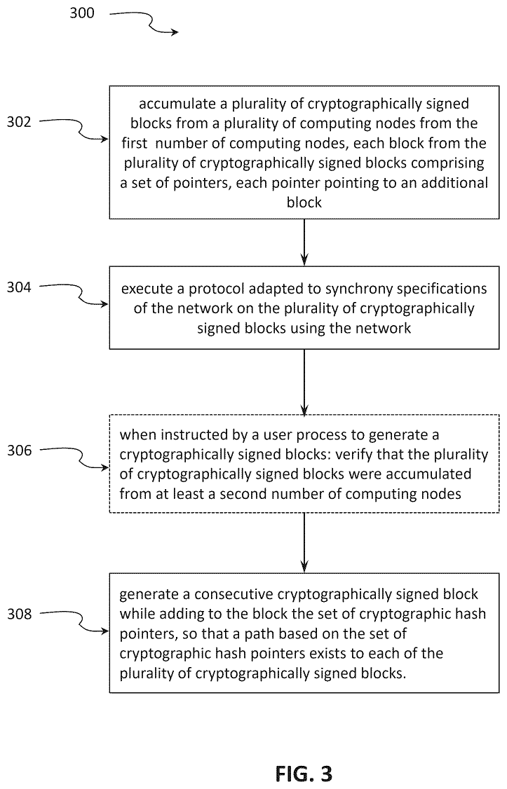

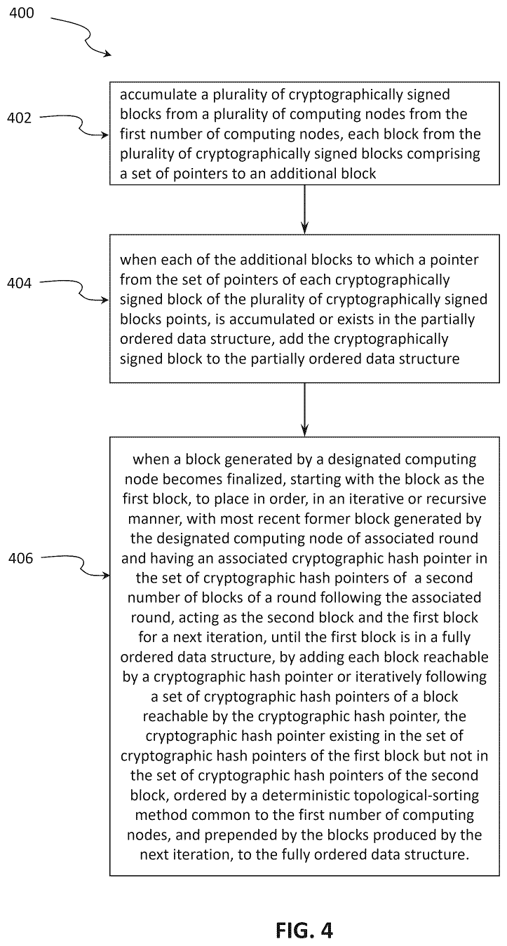

Referring now to the drawings, FIG. 1 is a schematic illustration of an exemplary system for block registration on distributed ledgers, according to some embodiments of the present invention. An exemplary block registration system environment 100 may execute processes such as 300 and/or 400 for block registration on distributed ledgers. Further details about these exemplary processes follow as FIG. 3 and FIG. 4 are described.

The block registration system 110 may include a set of interfaces to a network, as well as other devices and instruments. The interfaces may comprises an input interface 112, and an output interface 114. The block registration system may also comprise one or more processors 122 for executing processes such as 300 and/or 400, and storage 116, comprising a portion for storing code (program code storage 126) and/or memory for data, such as device and/or machine parameters, control scenarios, and/or the like. The block registration system may be physically located on a site, implemented as distributed system, implemented virtually on a cloud service, on machines also used for other functions, and/or by several options. Alternatively, the system, or parts thereof, may be implemented on dedicated hardware, FPGA and/or the likes. Further alternatively, the system, or parts thereof, may be implemented on a server, a computer farm, the cloud, and/or the likes. For example, the storage 116 may comprise a local cache on the device, and some of the less frequently used data and code parts may be stored remotely.

The input interface 112, and the output interface 114 may comprise one or more wired and/or wireless network interfaces for connecting to one or more networks, for example, a local area network (LAN), a wide area network (WAN), a metropolitan area network (MAN), a cellular network, the internet, a combination thereof, and/or the like. The input interface 112, and the output interface 114 may further include one or more buses 130. The buses may comprise wired and/or wireless interconnection interfaces, for example, a universal serial bus (USB) interface, a serial port, and/or the like. Furthermore, the output interface 114 may include one or more wireless interfaces for ledger related communication such as receiving requests from users, and the input interface 112, may include one or more wireless interfaces for receiving information from one or more devices. Additionally, the input interface 112 may include specific means for communication with one or more sensor devices such as a camera, microphone, a card reader, cellphone and/or the like. And similarly, the output interface 114 may include specific means for communication with one or more display devices such as a loudspeaker, display and/or the like.

The one or more processors 122, homogenous or heterogeneous, may include one or more processing nodes arranged for parallel processing, as clusters and/or as one or more multi core one or more processors. The processor may comprise units optimized for large number arithmetic operations, large matrices operations, and/or the like, such as Graphic Processing Units (GPU). The storage 116 may include one or more non-transitory persistent storage devices, for example, a hard drive, a Flash array and/or the like. The storage 116 may also include one or more volatile memory devices, for example, a random access memory (RAM) component, enhanced bandwidth memory such as video RAM (VRAM), and/or the like. The storage 116 may further include one or more network storage resources, for example, a storage server, a network attached storage (NAS), a network drive, and/or the like accessible via one or more networks through the input interface 112, and the output interface 114.

The one or more processors 122 may execute one or more software modules such as, for example, a process, a script, an application, an agent, a utility, a tool, an operating system (OS) and/or the like. The software modules may comprise a plurality of program instructions stored in a non-transitory medium within the program code 126, which may reside on the storage medium 116. For example, the one or more processors 122 may execute a process, comprising block registration on distributed ledgers, such as 300 and/or 400 and/or the like.

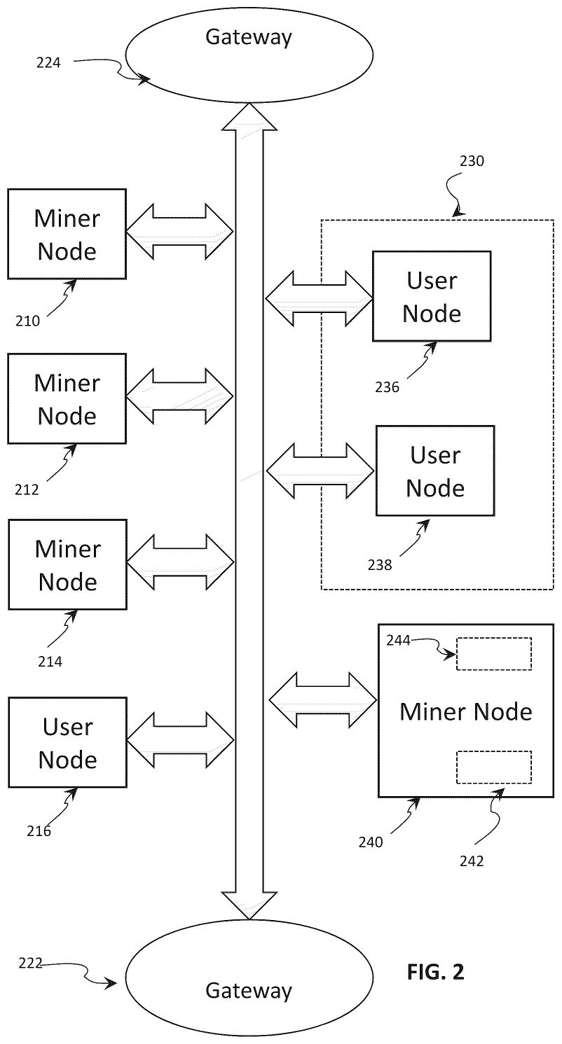

Referring now to, FIG. 2 which is a schematic diagram of an exemplary system for block registration on distributed ledgers, according to some embodiments of the present invention.

The network may be used for providing a plurality of users with a platform comprising a distributed ledger, and labelled as a LAN, WAN, a cloud service, a network for banking, trading non-fungible tokens (NFT), software as a service (SaaS), a compute server, and/or the like. The network may allow communication with virtual machines functioning as miner nodes, as shown in 210,212,214 and 240, as well as user nodes shown in 216, 236 and 238. The correspondence between virtual machines and physical machines may be of any positive rational number. For example, the physical machine shown in 230 hosts both virtual machines 236 and 238, however, the virtual machine 240 is implemented by both physical machines 242 and 244.

The network may interface the outside network, e.g. the internet, through gateways such as 224 and 222. Gateways may comprise features such as routing, security, load management, billing, and/or the like however some, or all of these features may also be otherwise handled by other machines in or outside the network.

Reference is also made to FIG. 3 which is a basic flow chart of a first exemplary process for block registration on distributed ledgers, according to some embodiments of the present invention. The exemplary process 300 may be executed for block registration on one or more distributed ledgers, for example for cryptocurrency, logging of sensitive information, information integrity validation, voting, medical records and/or the like. The process 300 may be executed by the one or more processors 122.

The exemplary process 300 starts, as shown in 302, with accumulate a plurality of cryptographically signed blocks from a plurality of computing nodes from the first number of computing nodes, each block from the plurality of cryptographically signed blocks comprising a set of cryptographic hash pointers, each cryptographic hash pointer pointing to an additional block.

The blocks may be received directly from the computing node which generated them, or indirectly through a different cordial node, which may be designated in some implementations. The miner which generated the block may be identified by the cryptographic signature, and may a payload, and also comprise a set of cryptographic hash pointers. The payload may include information, transactions, signatures, code, and the like, which may be verified by different means by the miner, and/or the like.

The cryptographic hash pointers may comprise pointers pointing to additional blocks known to the miner. The first block generated by a miner may have an empty set of cryptographic hash pointers, or point to a null, or an initial block. The following blocks may have a cryptographic hash pointers to the most recent block generated by the same miner, as well as cryptographic hash pointers to the most recent block received from each other miner.

Links to other blocks generated by the miner or other miners may also be included in the set of cryptographic hash pointers, added to the consecutive cryptographically signed block. However, preferred implementation generated the set of cryptographic hash pointers while prioritizing directed graph sources characterized by having no cryptographic hash pointer pointing to in the set of cryptographic hash pointers comprised by other blocks, i.e. the more recent blocks from each miner.

The exemplary process 300 continues, as shown in 304, with execute a protocol adapted to synchrony specifications of the network on the plurality of cryptographically signed blocks using the network.

The protocol may control the process of miners sharing the blocks, also referred to as dissemination. Three instances of the Cordial Miners protocol family are included in the disclosure, however variants thereof and other protocols may be developed in the future and also included in the scope of the claims. One instance is a counterpart to DAG-Rider, a Byzantine Atomic Broadcast (BAB) protocol in the asynchronous model. Another instance is a counterpart to HotStuff, an SMR protocol in the eventual synchrony model. A third instance is a hybrid protocol comprising elements from both.

The protocol adapted to synchrony specifications of the network may be selected from these instances, a variant, a future development, and/or the like, and chosen based on the network specification. These protocols may comprise sending the blocks to each of the other miners, directly, and/or through one or more designated computing nodes.

When required by the protocol adapted to the synchrony specifications, the exemplary process 300 continues, as shown in 306, with verifying that the plurality of cryptographically signed blocks received, comprises blocks of preceding round from at least a second number of computing nodes. The generating of a consecutive cryptographically signed block may be delayed until the second number of computing nodes a super, which may be also referred to a supermajority, is met.

Some of the protocol adapted to synchrony specifications, require each node to wait until receiving the most recent, or last round blocks from at least a second number of computing nodes before generating their consecutive cryptographically signed block. Some other protocols adapted to synchrony specifications may have less strict requirement, such as receiving at least one of the blocks from the three most recent rounds, from at least a second number of computing nodes, or may have no requirement for receiving former round blocks before generating their consecutive blocks.

And subsequently, as shown in 308, the process 200 may continue by generating a consecutive cryptographically signed block while adding to the block the set of cryptographic hash pointers, so that a path based on the set of cryptographic hash pointers exists to each of the plurality of cryptographically signed blocks.

Generating a consecutive cryptographically signed block may comprise generating the payload. Additionally, generating a consecutive cryptographically signed block may comprise adding to the block the set of cryptographic hash pointers, so that a path based on the set of cryptographic hash pointers exists to each of the plurality of cryptographically signed blocks.

When a cryptographic hash pointers exist to a block, the path may be of length 1. When the path is indirect, i.e. there is a cryptographic hash pointer to an additional block which has in the set of pointers a cryptographic hash pointer to another block, the path may be of length 2, and similarly a longer indirect path may exist. Paths to buffered blocks which are not yet included in the partially ordered data structure may also be generated. The set of paths as well as the blocks to which the cryptographic hash pointers point to, directly or indirectly, may be referred to as the closure of the consecutive cryptographically signed block.

Reference is also made to FIG. 4, which is a basic flow chart of a second exemplary process for block registration on distributed ledgers, according to some embodiments of the present invention.

The exemplary process 400 may be executed for executing one or more distributed ledger block registration protocols. The process 400 may be executed by the one or more processors 122.

The exemplary process 400 starts, as shown in 402, with accumulating a plurality of cryptographically signed blocks from a plurality of computing nodes from the first number of computing nodes, each block from the plurality of cryptographically signed blocks comprising a set of pointers to an additional block.

The plurality of cryptographically signed blocks may be from the current round, last round, and/or former rounds, and in some implementations a miner computing node may receive blocks from cycles the miner had not yet reached.

The block source may be identified by the cryptographic signature, and received directly or indirectly from the computing node of the plurality of computing nodes from the first number of computing nodes.

The exemplary process 400 continues, as shown in 404, with when each of the additional blocks to which a pointer from the set of pointers of each cryptographically signed block of the plurality of cryptographically signed blocks points, is accumulated or exists in the partially ordered data structure, add the cryptographically signed block to the partially ordered data structure.

When a block is received and each of the blocks pointed by a pointer in the block's set of cryptographic hash pointers were accumulated the block may be placed in the partially ordered data structure, also referred to as blocklace.

Some implementations may be configured to store a block from the plurality of cryptographically signed blocks in a buffer when at least one cryptographic hash pointer from the set of cryptographic hash pointers pointing to at least one unknown block. When the at least one unknown block is accumulated, the buffered block's location in the partially ordered blocklace may be determined and the buffered block may be moved from the buffer to the partially ordered data structure.

The exemplary process 400 continues, as shown in 406, with when a block generated by a designated computing node becomes finalized, starting with the block as the first block, to place in order, in an iterative or recursive manner, with most recent former block generated by the designated computing node of associated round and having an associated cryptographic hash pointer in the set of cryptographic hash pointers of a second number of blocks of a round following the associated round, acting as the second block and the first block for a next iteration, until the first block is in a fully ordered data structure, by adding each block reachable by a cryptographic hash pointer or iteratively following a set of cryptographic hash pointers of a block reachable by the cryptographic hash pointer, the cryptographic hash pointer existing in the set of cryptographic hash pointers of the first block but not in the set of cryptographic hash pointers of the second block, ordered by a deterministic topological-sorting method common to the first number of computing nodes, and prepended by the blocks produced by the next iteration, to the fully ordered data structure.

A block may be considered finalized when the block was generated by a designated node of a round, and at least the second number of the blocks of a second following round, comprising the block generated by the designated computing node of the second following round, have in each of a second associated set of cryptographic hash pointers, at least the second number of pointers pointing each to a block from a first following cycle, each have in a first associated set of cryptographic hash pointers, a cryptographic hash pointer pointing to the block, and the cryptographic hash pointer pointing to the block is the only cryptographic hash pointer, in the first associated set of cryptographic hash pointers, pointing to a block generated by the designated node of the round at the round. The second number may be two thirds of the first number, or a number above to thirds, for which the liveness and safety of the method may be shown, however a number less than two thirds of the first, general number of miners, may also be used.

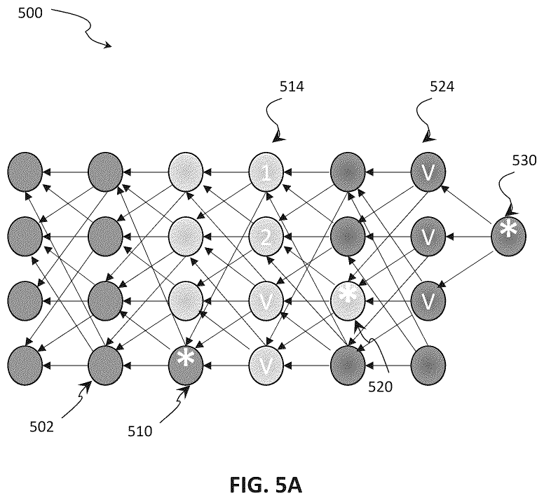

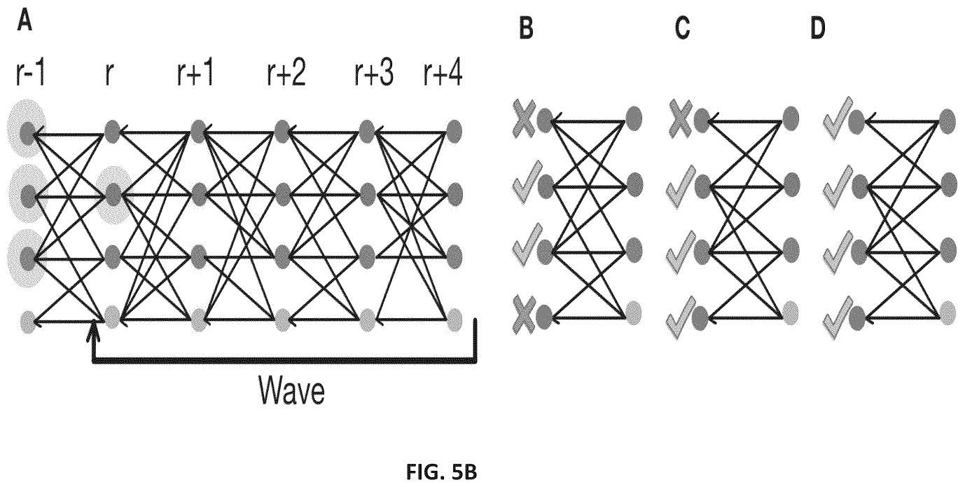

Reference is also made to FIG. 5A, which is an exemplary illustration of a partially ordered data structure, according to some embodiments of the present invention.

While the illustration 500 portrays the rounds as synchronous, wherein each of the miner generate their block at the same time, for better readability, the blocks may be generated at different times, however an arrow indicates that the block at the source was generated when the blocks it points to are already known. For example, the block numbered 502, generated by the bottom miner on the second round, has cryptographic hash pointers to the blocks from the first round of the top miner, the miner second from the top, and the block generated by the same miner. Since in this example 3 out of 4 is over ⅔ the supermajority of the former round clocks was accumulated and the block is cordial in this sense.

For readability, leader blocks are shown for odd rounds, marked by *, for example 510, 520, and 530. The leader block of the fifth round shown in 520 acknowledges three blocks from the fourth round, shown in 514, are marked by V and 2. The blocks marked by V and 1 from the fourth round acknowledge the leader of the third round shown in 510, and since they don't acknowledge a conflicting block they also approve it. However, only two blocks both acknowledge the third round leader and are acknowledged by the fifth round leader, thus the requirement for super-ratification or finalization is not met, and the third round block is just ratified.

The Sixth round, shown in 524, has three blocks, marked by V, that both acknowledge the fifth round leader and are acknowledged by the seventh round leader, shown in 530, thus the requirement for super-ratification is met for the fifth round leader, and thus the fifth round leader may be finalized. Due to the finalization of the leader shown in 520, miners having a snapshot as depicted of the partially ordered data structure, or blocklace, may deliver the brighter blocks and the smooth blocks which are in the closure of the fifth round leader 520. Note that the ordering function may first arrange the brighter blocks, giving priority to the deeper, i.e. third round blocks, and order blocks of each round by a deterministic order, such as lexicographic. Followingly, a similarly generated sub-chain of the smooth blocks from the first round too the third round may be added as a prefix.

The seventh round leader block is shown to acknowledge exactly three blocks, exactly as required for the block being cordial, however some implementations may determine different threshold for generating a block and ratifying a block.

It should be emphasized that the blocklace shown, and properties such number of miners, cordiality is a simplified example shown for readability and understandability, and should not be construed limiting the scope of the claims.

Reference is also made to FIG. 5B, which is an exemplary illustration of equivocations, approval and ratification in a partially ordered data structure, according to some embodiments of the present invention.

FIG. 5B illustrates an exemplary blocklace data structure, equivocations, approval and ratification. Four miners are shown, the top may be referred to as red, the second from the top (but-top) as green, the second from the bottom (but-bottom) as blue, and the bottom as yellow. Each circle represents a block and each line a hash pointer to the left block.

Subfigure A shows a single wave consisting of five consecutive rounds. The top block in round r with the halo may be the designated, or the leader block. Each of the highlighted blocks in yellow in rounds r+1 and r+4 may have a path to the leader block, enabling the leader block to be a finalized leader block. The blocks with a gray halo are ordered by t when the leader block becomes finalized. In subfigure B the top, top, red miner equivocates, and the top red block approved by the but-top green block of the next round, the bottom red block approved by the bottom yellow block of the next round, and the but-bottom blue block of the next round, observing both equivocating red blocks, approves neither, and hence neither of the red blocks has the three approvals (including the red block itself) needed for ratification. In subfigure C the blue block of the next round observes only the bottom red block and hence approves it, which together with the yellow block and the red block itself form a supermajority, and hence the bottom red block is ratified, but not the top one. In subfigure D the blue miner equivocates in the next round, with the top blue block of the next round approving the top red block, which together with the green and red form a supermajority that ratifies it. Similarly, the bottom blue block, the yellow block and the red (which is not illustrated) may ratify the bottom red block. Indeed, with two equivocators (red and blue) out of four, an equivocation may be ratified.

The main component of the Cordial Miners protocols is the blocklace, a distributed DAG-like structure that the miners jointly built, and is illustrated in FIG. 5B with four miners, each in a different color. The blocklace may constructed in rounds, each consisting of more than 12 n+f blocks from different miners. A set of blocks by more than 12 (n+f) miners may be termed a supermajority, wherein when f=0 a supermajority may be a simple majority.

Subfigure A of FIG. 5B presents an exemplary blocklace constructed by four miners so that each column is a single round representing blocks from different miners, and each row in the same color consists of blocks from the same miner. Thus, each correct miner creates a single block in each round.

Different miners may have different partial views of the blocklace, and a goal of the disclosure is to “converge” the order of the blocks to a consistent order for all the miners.

Each block may hold a set of transactions as well as pointers i.e. the edges in the DAG to blocks of previous rounds. When a miner observes a new round r with a supermajority of blocks, which may also be termed as a cordial round, the miner may create a new block b of round r+1 with pointers to the tips of the blocklace as known thereto up to round r, which are the blocks in the blocklace with no incoming edges.

A block may be considered to observe another if there is a path of pointers from one to the other. The tips are expected to include a supermajority of blocks of round r, however there may be blocks of earlier rounds not already observed by the blocks received in round r. E.g., when subfigure A represents the blocklace as the red miner observes it, then since round r+4 is cordial, the red miner may create a new block b in round r+5 with pointers to all the blocks in round r+4. The miner may send b to all other miners.

Cordial Miners may use the blocklace for the three algorithmic components of consensus: Dissemination, equivocation-exclusion, and ordering.

Referring now to the dissemination process. In some cases, dissemination may be implemented simply by each miner sending each new block to all other miners. However, faulty miners, communication problems, and the likes may cause failures, possibly intentionally, and may send new blocks only to some of the miners. Blocklace-based Byzantine-resilient dissemination may be provided by that a new block created by a correct miner may also serves as an ack/nak message, informing other miners or recipients of the blocks known by the sender at the time of sending and, by omission, also of the blocks not yet known to the sender. For example the but-top green block in round r+4 serves as an ack message for all the blocks that it observes, including the red, green, and blue blocks in round r+3. It also serves as a nak message for bottom, the yellow block of round r+3.

This facilitates upholding the principle of Cordial Dissemination: Send to other miners blocks you received and think they did not. In this example, when the red, top miner sends the block it creates to the but-top, green miner in round r+5, it will also send to the green miner the bottom, yellow block in round r+3.

Since Byzantine miners may equivocate. That is, send equivocating blocks to different honest miners. Two blocks b1, b2 may be consider equivocating if neither observes the other, i.e., there is no path of pointers from b1 to b2 or from b2 to b1. The blocklace may contain equivocations, and they must be excluded when each miner locally applies the ordering on the blocks in its blocklace to a sequence of final blocks

The supermajorities may be used to exclude equivocations so that for each set of equivocating blocks, at most one is included in the final output. In addition, after detecting an equivocation, honest miners may ignore the Byzantine miner, and stop including its blocks in the blocklace or disseminate them, so a Byzantine miner may equivocate at most once before being detected and ignored, limiting the power of the Byzantine miners.

Equivocation exclusion is part of the t ordering. Ordering the partially-ordered blocklace may be performed by topological sort of the DAG. The challenge is to ensure that all correct miners exclude equivocations and order the blocks identically so that they all produce the same total order. To this end, the blocklace may divided to waves, each consisting of several rounds, the number of which may be different for eventual synchrony and ES and asynchrony (for example 2 and 5 rounds per wave, respectively). For example, subfigure A of FIG. 5B depicts an exemplary asynchronous version which has 5 rounds in each wave.

For each wave, one of the miners may be elected as the leader, and when the first round of the wave has a block produced by the leader, the block may be referred to as the leader block. The figure depicts the sub-top green block in round r in the green halo as the block leader of that wave. When a wave ends, i.e., when the last round of the wave is cordial, the leader block becomes finalized when it has sufficient approving blocks, namely, the finalized leader block is not equivocating and there is a supermajority of blocks each observing a supermajority that observes the leader block.

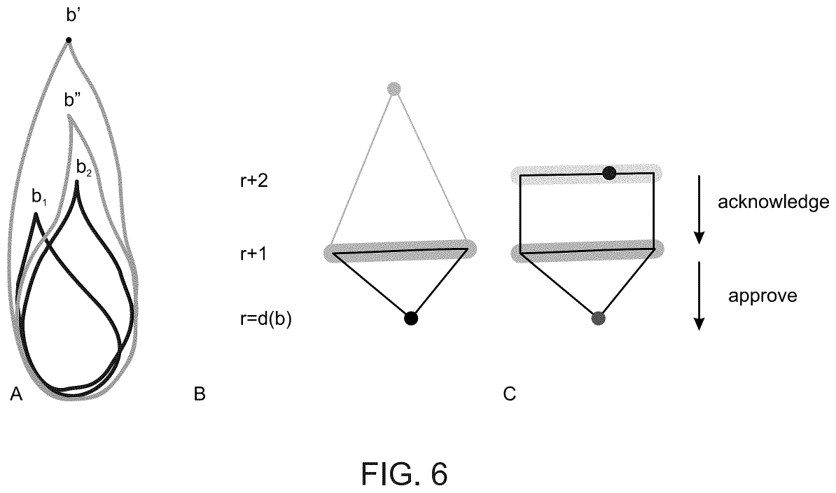

Reference is also made to FIG. 6, which is a set of diagrams illustrating exemplary causal relations of blocks, according to some embodiments of the present invention.

The terms Acknowledgement, Approval, Equivocation, Ratification, and Super-Ratification are related to causal relations of blocks, as represented by the directed acyclic graph generated by the sets of cryptographic hash pointers:

The left figure (A) is an exemplary Equivocation: The initial blocks are at the bottom, inclusion implies >. The blocks b1, b2 are an equivocation generated by the same miner. According to the figure, the block b″ approves b2 since it acknowledges b2, namely b″>b2 and does not acknowledge any conflicting block, in particular it does not acknowledge b1. However, since b′ acknowledges b″ it acknowledges, i.e. has causal link, to both b1 and b2 and hence does not approve the equivocating b1, nor b2.

The middle figure (B) is an exemplary Ratification: The block, represented by a black dot at the bottom, at round r is ratified by the block, shown as a gray dot on top at round ≥r+2, as the black block is approved by a supermajority at round r+1, shown as the middle horizontal line that is acknowledged by the gray block.

The right figure (C) is an exemplary Super-ratification: A leader block, shown as the dot at the bottom at round r is super-ratified if there is a supermajority, namely at least a second number of computing nodes, shown as the light horizontal line, that includes a leader block shown as a dot at round r+2, each member of the supermajority ratifies the leader at round r, namely each acknowledges a supermajority, shown as the dark horizontal line, at round r+1 that approves the leader of round r. Note that approval is the stronger requirement indicating that in addition to the causal relation, there is no conflicting block acknowledged, while acknowledgement requires only the causal relation.

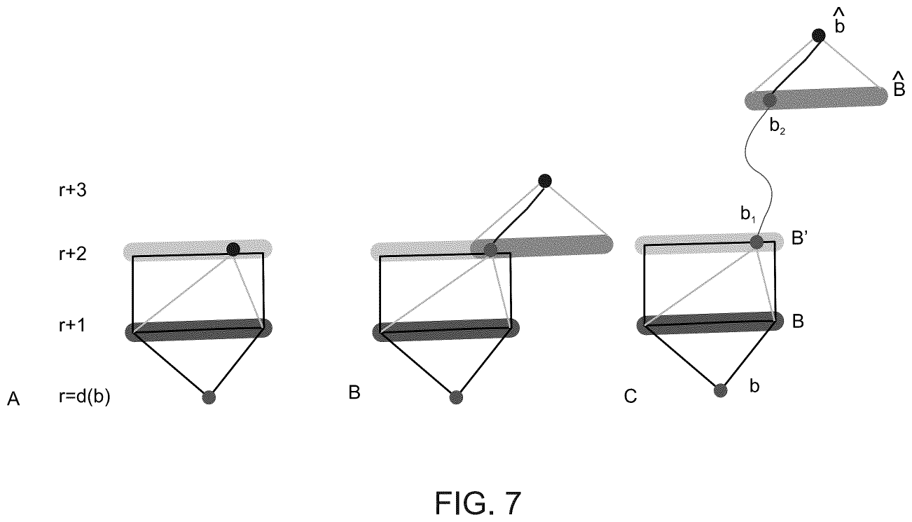

Reference is also made to FIG. 7, which is a set of diagrams illustrating exemplary finalizations of blocks, according to some embodiments of the present invention.

The finality of a Super-Ratified Leader block is demonstrated for a leader block of round r shown as the dot in the bottom, which is super-ratified, and therefore it may be ratified by any subsequent leader shown as the top dot. The left figure (A) shows the leader is at round r+2 meets the definition of super-ratification for the leader block of round r, i.e. it acknowledges a supermajority that approves the leader. In the center figure (B) and the right figure (C) The following leader is at a subsequent round r+k, k>2, then, being cordial, it acknowledges a supermajority marked as a horizontal line of the previous round r+k−1, which must have a correct agent marked by the dot of r+2 in common with the super-ratification supermajority at round r+2, marked by the light horizontal line. (B) When the supermajorities are of the same round k=2, then there is at least one block that connects the recent, top leader to the bottom leader via the approving supermajority shown in the darker horizontal line at round r+1. (C) Otherwise When the supermajorities are of different rounds, i.e. k>2, there are two blocks b1, b2 of the recent agent B\hat{ } and light line B′ supermajorities, which are connected via a path since the blocks belong in to the supermajorities are correct, connecting the top leader \hat{ }b to the bottom leader b via the approving supermajority B shown in the dark green horizontal line at round r+1. In all cases, the recent leader \hat{ }b ratified the blue leader b.

The designated computing node, also referred to as the leader of a round, and which generates the leader block of the round, may be designated by a method selected from the group consisting of round robin, a predetermined pseudorandom series, and a global perfect coin.

Some implementation may use Retroactive Leader Election via Shared Coin, as in the model of asynchrony the adversary may have complete control over the order of message delivery, indefinitely. The method employed for example by DAG-Rider applies a shared random coin and elects the leader retroactively thereby, and to allow more rounds for a final leader to emerge. Since miners are cordial, the notion of common core may be applied to prove a lower bound on the probability of a leader being finalized despite such a powerful adversary. The same approach may be applied for the Cordial Miners protocols, at the cost of delaying expected finality from 2 rounds to 4 rounds, as the approach uses threshold signatures, a secure method for key distribution is needed.

Ratified and Finalized Leader Blocks may be defined as follows: A block b∈B may be considered ratified when there is at least the second number, i.e. a supermajority of blocks at depth d(b)+1 that approves b. A leader block b of depth r may be considered finalized if there is a supermajority B of depth d(b)+2 that includes a leader block such that each member of B ratifies b. It may be shown that a finalized block is ratified by any subsequent cordial block. When b is finalized leader in B, then it may be ratified by any subsequent leader b′ [symbol] b in B due to the following: A leader block b finalized via supermajorities B′ and B as shown in the middle figure, and assume that b\hat{ } is some subsequent leader block that, being cordial, acknowledges a supermajority of the preceding round B\hat{ }. By counting, at least one block b₁∈B′ and one block b₂∈B\hat{ } are both p-blocks by the same correct miner p∈Π. Since p is not an equivocator b₂>b₁. Hence b\hat{ }>b₂>b₁ and b₁ ratifies b, thus b\hat{ } ratifies b. This shows that given a blocklace B, a finalized leader b in B may be ratified by any subsequent finalized leader, hence included in the sequence of finalized leaders. Hence, the finalized sequence up to a finalized leader b is fully-determined by b itself independently of the continuously changing identity of the last finalized leader. Hence the final sequence up to a final leader b may be ‘cached’ and will not change as the blocklace increases in size. Super-ratified, or finalized leaders may be the anchors of finality in a growing chain, each used as a basis to trace history backwards till the preceding ratified leader. The term ‘Okazaki fragments’, or sub-chains may be used for the sequences computed backwards from each finalized leaders to its predecessor, as an analogy with the way one of the DNA strands of a replicated DNA molecule may be elongated via the stitching of backwards-synthesized Okazaki-fragments.

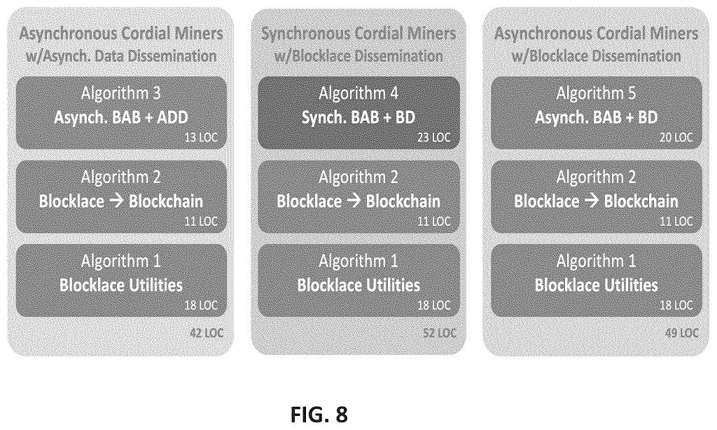

Reference is also made to FIG. 8, which is a table of exemplary protocols adapted to synchrony specifications of the network, according to some embodiments of the present invention.

The protocols are presented as algorithmic components written in pseudo-code, with some components shared between them: The Asynchronous Cordial Miners protocol with modular Asynchronous Data Dissemination consists of Algorithms 1, 2, and 3. The Synchronous Cordial Miners protocol with Blocklace Dissemination consists of Algorithms 1, 2, and 4. The Asynchronous Cordial Miners protocol with Blocklace Dissemination consists of Algorithms 1, 2, and 5. The Figure presents the shared and distinct (green/blue/red) components of three protocols in the family. Algorithm 1 contains a description of a block in a blocklace and blocklace utilities. Algorithm 2 describes the local conversion each miner executes with the function t converting its local copy of the partially-ordered blocklace into a totally-ordered sequence of blocks. Then there are two algorithms: Algorithm 3, an all-to-all communication protocol that is analogue to DAG-Rider and uses asynchronous data dissemination as the underlying communication protocol. Algorithm 4, a leader-based communication protocol that is analogue to HotStuff. Algorithm 5 may be considered a hybrid of Algorithm 3 and Algorithm 4: It uses all-to-all communication as in Algorithm 3, but eschews an external dissemination protocol by the leader of each round sending any backlog needed for dissemination as in Algorithm 4. Several optimizations such as excluding faulty and nonresponsive leaders may also be used in all protocols.

For the purpose of Safety and Liveness property analysis three models of communication with an adversary are considered: Asynchrony, where an adversary controls the finite message delay of each message. Eventual Synchrony, where an adversary controls message delay for an unknown but finite number of messages, beyond which messages arrive within bounded delay. Eventual Random Asynchrony, where an adversary controls message delay for an unknown but finite number of messages, beyond which messages arrive with random delay of finite expectation.

Eventual asynchrony is a natural counterpart to eventual synchrony, however it is apparently unexplored. The Synchronous Cordial Miners protocol may apt for eventual synchrony and the Asynchronous Cordial Miners protocols may be applied for eventual asynchrony with pseudorandom leader selection and to asynchrony with random retroactive shared-coin leader selection. Both protocols address Byzantine Atomic Broadcast.

Algorithms 1 & 2 are shared components between the protocols adapted to network synchrony specifications. Algorithm 1 comprises basic blocklace utilities, Algorithm 2 realizes a blocklace ordering. Algorithm 3 incorporates Algorithms 1 & 2 with a modular asynchronous data dissemination protocol to realize Byzantine Atomic Broadcast (BAB) in the model of eventual asynchrony/asynchrony, depending on the leader selection function applied. Algorithm 4 incorporates Algorithms 1 & 2 with cordial all-to-leader-to-all blocklace dissemination to realize Byzantine Atomic Broadcast in the eventual synchrony model. Algorithm 5 integrates ideas from the first two: It incorporates Algorithms 1 & 2 with cordial all-to-all block communication and cordial leader-to-all blocklace dissemination to realize Byzantine Atomic Broadcast in the model of eventual asynchrony/asynchrony, depending on the leader selection function employed. Length in lines of pseudocode is noted for each.

It should be noted that these algorithms are exemplary and variants may be apparent to the person skilled in the art. Or developed in the future, and within the scope of the claims.

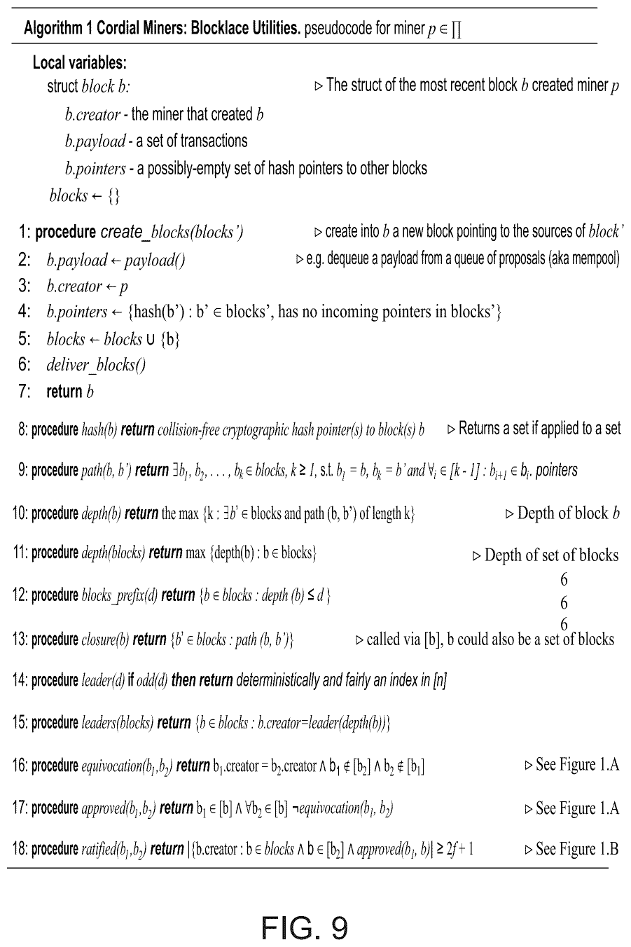

Reference is also made to FIG. 9, which is an exemplary pseudocode of utility functions related to a partially ordered data structure, according to some embodiments of the present invention.

These utilities are exemplary implementations of the basic elements of the method, such as definition of a block, collision free cryptographic hashing, path extraction, closure extraction, depth calculation, leader designation and labelling, checks for approval, ratifications, equivocations, and the like.

For example, equivocation is defined as when two blocks were generated by the same miner node, however neither is in the closure of the other blocks.

Reference is also made to FIG. 10, which is an exemplary pseudocode of a function for adding blocks from a partially ordered data structure to a fully ordered data structure, according to some embodiments of the present invention.

Adding blocks from a partially ordered data structure to a fully ordered data structure may be performed by a deterministic function t that incrementally converts a blocklace into a sequence of some of its blocks. It may be shown that t is monotonic with respect to the subset relation, provided no more than f, i.e. less than a third of miners, equivocate. The intention is that each miner in a blockchain consensus protocol may execute t to locally compute the final output sequence of blocks from its local copy of the blocklace as input, as realized by Algorithm 2. Monotonicity ensures finality, as it implies that the output sequence will only extend while the input local blocklace increases over time. Monotonicity is a sufficient condition for the safety of each protocol that uses. To ensure liveness, one has to argue that every valid block in the input blocklace will eventually be in the output of t, this argument is protocol dependent and argued separately for the asynchronous protocol and the synchronous protocol.

The following recursive ordering function t may map a blocklace into a sequence of blocks. The entire sequence may be computed backwards from the last final leader, afresh by each application of t. Practically, a sequence up to a finalized leader is final as shown in FIG. 7, and hence may be cached. This allows t to be iteratively compute sub-chains, which may referred to as ‘Okazaki-fragment’ increments from the new final leader backwards to the previous final leader.

A fixed ordering function, for example direct or hashed lexicographic, marked s, may map a blocklace to a sequence of blocks consistent with [symbol] . The function τ: 2^{B}→B* and may be defined for a blocklace B⊂B backwards, from the last output element to the first, as follows: When B has no final leaders then τ(B):=Λ. Else when b is the last final leader in B, Then τ(B):=τ′(b), where τ′ is defined recursively: τ(b):=s([b]) if [b] has no leader ratified by b, else τ′(b′)·s ([b]\[b′] when b′ is the last leader ratified by b in [b].

Note that τ′ may use the notion of a leader ratified by another leader, rather than a finalized leader. It may be shown that when there are less than f equivocators, a final leader is final, in the sense the leader may be guaranteed to be ratified by any subsequent leader, finalized or not. The monotonicity and finality of τ, may be shown by that when there are at most f equivocators, the function τ is monotonic with respect to ⊆, namely B⊆B′ for two blocklaces with at most f equivocators implies that τ(B) [symbol] τ(B′), and in this sense membership in τ is final. The property may be shown for a given blocklaces B⊂B′⊆B₂₁. If τ(B)=Λ the claim holds vacuously. When b is the last final leader in B. If B′ has no final leader not in B, then τ(B)=τ(B′) and the claim also holds vacuously. When b₁, . . . , bₖ, k≥1, is the sequence of final leaders in B′\B. It may be shown by the definition of τ, τ(B′)=τ(B)·s([b₁]\[b])· . . . s([bₖ]\[bₖ₋₁]), namely τ(B) [symbol] τ(B′).

Consistent triplet may be shown by three sequences x, x′, x″, when x′ [symbol] x and x″ [symbol] x, x′ and x″ are consistent. The consistency of output sequences ensures that the output sequences computed by miners based on their local blocklaces would be consistent as long as there are there are at most f equivocators. The consistency may be shown when B, B′⊂B are grounded with at most f equivocators in B:=B′∪B″ then τ(B′) and τ(B″) are consistent.

The monotonicity of τ with at most of equivocators, τ(B) [symbol] τ(B) and τ(B″) [symbol] τ(B), may be shown by that τ(B′) and τ(B″) are consistent. Note that t may not output all the blocks in its input, as blocks not acknowledged by the last finalized leader in its input are not delivered to the fully ordered data structure.

The liveness or fairness of t may be shown for a block b∈B which is acknowledged by the last final leader in B, and therefore included in τ(B). Therefore every block known to a correct miner will be known to all correct miners, and if every finalized leader has a successor, then every block will be eventually acknowledged by some finalized leader and therefore be delivered by τ. Algorithm 2 implementers these conditions and maintains deliveredBlocks that includes the prefix of the output of t that it has already computed.

When adding a new block to its blocklace as shown in line 24, it computes the most-recent finalized leader b₁ as defined, and applies tau to it, which is intended to be a literal realization of the definition of τ, optionally with the optimization, that a recursive call with a delivered block is returned. Hence the following proposition: It may be shown that Tau implements t given the safety of every protocol that employs Algorithm 2 for ordering a blocklace; in particular, the safety of the asynchronous and synchronous Cordial Miners protocols.

It should be emphasized that variants of the protocol are apparent to the person skilled in the art and are within the scope of the claims.

Reference is also made to FIG. 11A, which is an exemplary pseudocode of a protocols adapted to synchrony specifications of the network, according to some embodiments of the present invention.

The protocol based on Algorithm 3 is a counterpart to DAG-Rider, a BAB protocol designed for the asynchronous model. It assumes an adaptive adversary that eventually delivers messages between any two correct miners. In DAG-Rider the miners jointly build a DAG of blocks, with blocks as vertices and pointers to previously-created blocks as edges, divided into strong and weak edges. Strong edges are used for the commit rule, and weak edges are used to ensure fairness. The protocol may be based on an underlying reliable broadcast protocol of choice, which ensures that eventually the local DAGs of all correct miners converge and equivocation is excluded. Each miner may independently converts its local DAG to an ordered sequence of blocks, with the use of threshold signatures to implement a global coin that retrospectively chooses one of the miners as the leader for each round. The decision rule for delivering a block is if the vertex created by the leader is observed by at least 2f+1 miners three rounds after it is created. DAG-Rider has an expected amortized linear message complexity, and expected constant latency.

The Asynchronous Cordial Miners protocol is our DAG-Rider counterpart. The protocol nay be based over an underlying data dissemination protocol such as Fischer et al's Impossibility of distributed consensus with one faulty process, and combines Algorithms 1, 2 & 3. Algorithm 3 is based over an asynchronous data dissemination protocol as a sub-protocol, so that when a miner executing the Cordial Miners protocol calls disseminate (b), it sends the block b to all other miners. This ensures that 2f+1>f+1 correct miners receive b, satisfying condition for asynchronous data dissemination (ADD) to operate correctly.

A miner that receives a proper block b wherein proper may refer to signed, cordial, with no dangling pointers, and/or the like, for the first time initiates the ADD protocol with b. Every shard of b created by the ADD protocol may be tagged with the hash value of b, so that multiple instances of the ADD protocol on multiple blocks may proceed concurrently, namely asynchronously and in parallel, without confusing between the blocks of the shards. When the ADD protocol reconstructs a block b′, the receipt condition of the Cordial Miners protocol may be fulfilled, with block b′.

The correctness of ADD may ensure that every block disseminated by a correct miner will eventually be reconstructed and received by every correct miner. The Asynchronous Cordial Miners protocol is designed for the model of eventual asynchrony, wherein an adversary may control message delay for an unknown but finite number of messages, beyond which messages arrive within bounded delay. The dissemination component may be called by disseminate (m) for some block b and can output receipt (b). The underlying protocol may guarantees that if a correct miner calls disseminate (b) or receipt (b) then eventually all correct miners perform receipt (b).

Algorithm 3 may buffer incoming blocks as shown in line 65, receive them when they have no dangling pointers as shown in line 39, and when observing a new cordial round, as shown in line 72. Algorithm 3 may create a block for the most recent cordial round in which it has not participated as shown in line 22 and disseminates the block for the most recent cordial round. The dissemination protocol may thereby ensure that all correct miners eventually the same blocks.

An adversary, familiar with the ‘celebrated FLP theorem’ may order message delivery so that in every round the supermajority first observed by all correct miners will not include the leader of that round. Thereby, no ratified leader, let alone a finalized, may exist. However, the eventual asynchrony model the adversary only controlling delivery times for some finite number of messages, and random network delays may delay followingly. Hence, from any point in the computation, a leader will eventually be finalized, and blocks acknowledged by it and not yet delivered may be delivered.

Hence, Algorithm 3 may be shown to satisfy the liveness requirement by considering a suffix of an infinite computation of Algorithm 3 beyond the control of the adversary. The underlying asynchronous data dissemination protocol may ensure that every block b known to a miner will be known eventually to every miner. The probability of each leader block in this suffix being ratified by its successor is greater than some fixed e, hence the probability of a leader block being finalized is greater than some smaller but fixed E′. Hence the probability measure of an infinite computation in which no correct leader block being finalized is zero. Hence, for any block b and point t in the computation, some leader block b′ that acknowledges b will be finalized at a point later than t′ with probability 1. Thus for any block b known to a correct miner, there will be a subsequent final leader block b′ that acknowledges b and hence delivers b, satisfying the liveness requirement.

In algorithm 3, generating a consecutive cryptographically signed block comprises verifying that the plurality of cryptographically signed blocks comprising blocks of preceding round from at least a second number of computing nodes, i.e. a supermajority, to meet the cordiality requirement.

It should be emphasized that variants of the protocol are apparent to the person skilled in the art and are within the scope of the claims.

Reference is also made to FIG. 11B, which is an alternative exemplary pseudocode of a protocols adapted to synchrony specifications of the network, according to some embodiments of the present invention.

In this alternative protocol, a correct block may be buffered until it has no dangling pointers, and be consider received in response to completion of the pointers. After including the received block in the blocklace a miner may call τ (Line 47), which may produce new blocks when adding the received block results in a new final leader block.

When a new round is completed in the blocklace (Line 48), the miner may create a new block (Line 49), compute the new round (Line 50), and send the new block to the other, fellow miners. The package sent to miner q may contain any blocks up to the previous round that p knows that q might not know, based on the last block received from q (Line 52). Note that as the network is reliable, send is defined to be idempotent, namely to send each block to each agent at most once.

This is an example when blocks of the round preceding by a predetermined number, two in this example, are received from each of the at least a second number of computing nodes, and the at least one of the first number of computing nodes meets the functionality requirement, the miner sends the blocks indicated unknown to at least one of the first number of computing nodes to the at least one of the first number of computing nodes.

It should be noted that there is a tradeoff between latency and message complexity, and there is a range of possible optimizations and heuristics. This alternative exemplary protocol is a latency-optimal Cordial Miners protocols in which every block is communicated among every pair of correct miners, however every block may be communicated also every trio, quartet, dozen, and/or the like.

Reference is also made to FIG. 12, which is another exemplary pseudocode of a protocols adapted to synchrony specifications of the network, according to some embodiments of the present invention.

Algorithm 4 is a counterpart to HotStuff, which is an SMR protocol designed for the eventual synchrony model. The protocol comprises all-to-leader, leader-to-all communication: In each round, a deterministically-chosen designated leader may propose a block to all and collects from all signatures on the block. Once the leader has 2f+1 signatures, it the designated node, namely the leader may combine them into a threshold signature, which it sends back to all. The decision rule for delivering a block may be three consecutive correct leaders. This may lead to a linear message complexity and constant latency in the good case. The protocol may delivers a block when there are three correct leaders in a row, which is guaranteed to happen after GST as defined by the eventual synchrony model. The Synchronous Cordial Miners protocol, designed for the model of eventual synchrony, comprises Algorithms 1, 2 & 4. Unlike the Asynchronous Cordial Miners protocol (Algorithm 3), which may rely on another protocol to perform dissemination, the Synchronous Cordial Miners protocol in Algorithm 4 employs the blocklace structure to perform dissemination. Therefore, each miner maintains a history array that records its communication history with the other miners, and updates it upon receiving a block, as shown in line 49, and upon sending one, as shown in line 78.

Registering communication history enables cordial miner nodes to indicate a block as unknown to at least one of the number of computing nodes until either the block or a block comprising at least one cryptographic hash pointer from the set of cryptographic hash pointers pointing the block is received from the at least one of the number of computing nodes, or the block is sent to the at least one of the number of computing nodes.

Maintaining a communication history data structure for storing pointers of cryptographically signed blocks received from each of the first number of computing nodes, and a cryptographically signed blocks, and/or cryptographically signed blocks sent to each of the first number of computing nodes may be used for indicating a block as unknown to at least one of the first number of computing nodes.

An ordinary, non-leader, miner p may simply send the cryptographically signed block b it has created, which includes pointers to the blocks p knows, to the leader as shown in line 77. A designated node, or the leader p, on the other hand, may send to each responsive miner q not only the block b, but also all the blocks that p knows but, to the best of p's knowledge, q does not, namely [b]\[history[q], as shown in line 76. Excluded from the closure of b it is the closure of all q-blocks known to p and all blocks p has sent to q, both recorded in history[q] of miner p. A miner q is considered responsive shown in line 63, to p, when q has responded to the last block p has sent to q. When sending a block to miner q, the miner p may use their communication history to create a package of all blocks p knows, which q may not know, and sends the whole package. Based on these packages, it may be shown that in Algorithm 4, when a correct miner knows a block b, then eventually every correct miner will know b.

For a correct miner p with block b∈blocks, and a miner q, when q is correct then eventually p will send a block to q, with one of them being a leader. When at that time the communication history of p with q shows that q knows b p, the block is known to both. Else, p may include b in its package to q, together with all blocks in [b] for which p has no evidence that q knows, based on their communication history. Followingly q may eventually receive the package. The package has no blocks with dangling pointers since p included in the package all the blocks q may not know which were known to p, hence q may receive it and include it together with b in its blocks. Unlike Algorithm 3, in which block communication is all-to-all, Algorithm 4 block communication may be from all-to-leader-to-all, requiring less synchronization, as only leaders need to be cordial, and not all miners as in Algorithm 3, and in the good case reduces message complexity, since the leader of each round may serve as a relay for all miners for that round. As a result, the argument for the liveness of the protocol is a bit different. Following that every block known to a correct miner will be known to every correct miner, a suffix of an infinite computation beyond the control of the adversary may be present. Every miner may eventually reach the suffix despite the adversary as timeout may be reached. In this synchronous suffix, the probability of a leader block being ratified by its successor may be (⅔)², and the probability of a leader block being finalized may be (⅔)³. Hence the probability measure of an infinite computation in which no correct leader block being finalized is zero. Hence, for any block b and any point t in the computation, some leader block b′ that acknowledges b will be final at a point later than t′ with probability 1. Thus for any block b known to a correct miner, there will be a subsequent final leader block b′ that acknowledges b and hence delivers b, satisfying the liveness requirement.

Algorithm 4 is an exemplary protocol adapted to synchrony specifications of the network in which when a block from the plurality of cryptographically signed blocks is indicated unknown to at least one of the first number of computing nodes, the designated leader node may send the block to a designated computing node. Some variants may, send the block to a designated computing node when a block from the plurality of cryptographically signed blocks is indicated unknown to at least one of the first number of computing nodes, to be sent to the at least one of the first number of computing nodes.

It should be emphasized that variants of the protocol are apparent to the person skilled in the art and are within the scope of the claims.

Reference is also made to FIG. 13, which is an additional exemplary pseudocode of a protocols adapted to synchrony specifications of the network, according to some embodiments of the present invention.

Algorithm 5 is a hybrid of Algorithm 3 and Algorithm 4. Algorithm 5 employs all-to-all block communication as Algorithm 3. But rather than employing an underlying asynchronous data dissemination protocol, it performs dissemination en passant, similarly to Algorithm 4, an ordinary, non-leader, miner p may send the block b it has created, which includes pointers to the blocks p knows, to all miners as shown in line 77. A designated leader p, may operate similarly to a leader in Algorithm 3, by sending to each responsive miner q not only the block b, but also all the blocks that p knows but, to the best of p's knowledge, q does not, namely [b]\[history[q]. This package may be constructed as in line 76. A miner q may be considered responsive as shown in line 63, by p if q has responded to the last block p has sent it.

Algorithm 5 may require the designated leader node to verify that blocks of the preceding round are received from each of the at least a second number of computing nodes the plurality of cryptographically signed blocks were accumulated, or that the accumulated blocks comprise blocks of preceding round from at least a second number of computing nodes before generating a consecutive cryptographically signed block. The designated leader may also send the blocks indicated unknown to at least one of the first number of computing nodes to the at least one of the first number of computing nodes, when the at least one of the first number of computing nodes meets the functionality requirement.

All miners in algorithm 5 may send the consecutive cryptographically signed block to each of the first number of computing nodes which meets a functionality requirement. The functionality requirement may comprise not equivocating, responsiveness, cordiality, and/or the like.

When a correct miner knows a block b, then eventually every correct miner may know b, since for a correct miner p with block b E blocks, and miner q, when q is correct then eventually it will send a block to p, and consider a subsequent round r in which p is a cordial leader. If at round r communication history of p with q shows that q knows p, the block is known. Otherwise, p may include b in its package to q, together with all blocks in [b] for which p has no evidence that q knows, based on their communication history. Therefore q may eventually receive the package. The package may have no blocks with dangling pointers since p includes in the package everything q might not know, hence q can receive it and include it together with b in its blocks.

Algorithm 5 may be shown to satisfy the liveness requirement of Definition 1.3.by a suffix of an infinite computation of Algorithm 5 beyond the control of the adversary. Since every block b known to a miner will be known eventually to every miner, similarly to the former algorithms.

Algorithm 6 comprises optimization utilities, such as functions to check when a miner meets functionality requirements such as not being an equivocator, and functions to check properties such as when a block is valid, for example proper, cordial and not an equivocation.

Optimizations for excluding miners that are faulty, due to equivocation, non-responsiveness, and/or by not being cordial may also be used. These can be easily taken further in various directions. For example by improving leader utilization by bypassing immediately, i.e. without timeout, rounds with a faulty leader.

It should be emphasized that variants of the protocol are apparent to the person skilled in the art and are within the scope of the claims.

It is expected that during the life of a patent maturing from this application many relevant distributed computing synchronization models, ordering algorithms, and the like will be developed and the scopes of the claims and the terms network, synchrony, and hash is intended to include all such new technologies a priori.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a round number format. It should be understood that the description in range format is merely for convenience and brevity and should not be construed as an inflexible limitation on the scope of the invention. Accordingly, the description of a round should be considered to have specifically disclosed all the practical ordering regimes of distributed computing computations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicants that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A system configured for distributed consensus ordered block registration using a partially ordered data structure, and communicating with a first number of computing nodes through a network, the system comprising:
at least one processing circuitry configured to:
accumulate a plurality of cryptographically signed blocks from a plurality of computing nodes from the first number of computing nodes, each block from the plurality of cryptographically signed blocks comprising a set of cryptographic hash pointers, each cryptographic hash pointer pointing to an additional block;
execute a protocol adapted to synchrony specifications of the network on the plurality of cryptographically signed blocks using the network; and
generate a consecutive cryptographically signed block while adding to the block the set of cryptographic hash pointers, so that a path based on the set of cryptographic hash pointers exists to each of the plurality of cryptographically signed blocks.

2. The system of claim 1, wherein the set of cryptographic hash pointers added to the consecutive cryptographically signed block is generated while prioritizing sources having no cryptographic hash pointer pointing to in the set of cryptographic hash pointers comprised by other blocks.

3. The system of claim 1, wherein the processing circuitry is further configured to store a block from the plurality of cryptographically signed blocks in a buffer when at least one cryptographic hash pointer from the set of cryptographic hash pointers pointing to at least one unknown block.

4. The system of claim 3, wherein the processing circuitry is further configured to move the block from the buffer to the partially ordered data structure when the at least one unknown block is accumulated.

5. The system of claim 1, wherein a block is indicated unknown to at least one of the number of computing nodes until either the block or a block comprising at least one cryptographic hash pointer from the set of cryptographic hash pointers pointing the block is received from the at least one of the number of computing nodes, or the block is sent to the at least one of the number of computing nodes.

6. The system of claim 1, further comprising maintaining a communication history data structure for storing pointers of cryptographically signed blocks received from each of the first number of computing nodes, and a cryptographically signed blocks is indicated unknown to at least one of the first number of computing nodes according to the communication history data structure.

7. The system of claim 6, wherein the protocol adapted to synchrony specifications of the network comprising when a block from the plurality of cryptographically signed blocks is indicated unknown to at least one of the first number of computing nodes, send the block to a designated computing node.

8. The system of claim 7, wherein generating a consecutive cryptographically signed block further comprising verifying that the plurality of cryptographically signed blocks comprising blocks of preceding round from at least a second number of computing nodes; and the protocol adapted to synchrony specifications of the network further comprising:
send the consecutive cryptographically signed block to each of the first number of computing nodes which meets a functionality requirement; and
when the at least one processing circuitry implementing the designated computing node, when blocks of the preceding round are received from each of the at least a second number of computing nodes, and the at least one of the first number of computing nodes meets the functionality requirement, send the blocks indicated unknown to at least one of the first number of computing nodes to the at least one of the first number of computing nodes.

9. The system of claim 7, wherein generating a consecutive cryptographically signed block further comprising verifying that the plurality of cryptographically signed blocks comprising blocks of preceding round from at least a second number of computing nodes; and the protocol adapted to synchrony specifications of the network further comprising:
send the consecutive cryptographically signed block to each of the first number of computing nodes which meets a functionality requirement; and
when the at least one processing circuitry implementing the designated computing node, when blocks of the round preceding by a predetermined number, are received from each of the at least a second number of computing nodes, and the at least one of the first number of computing nodes meets the functionality requirement, send the blocks indicated unknown to at least one of the first number of computing nodes to the at least one of the first number of computing nodes.

10. The system of claim 6, wherein the protocol adapted to synchrony specifications of the network further comprising when the at least one processing circuitry implementing the designated computing node:
generating a consecutive cryptographically signed block further comprising verifying that the plurality of cryptographically signed blocks comprising blocks of preceding round from at least a second number of computing nodes; and
when a block from the plurality of cryptographically signed blocks is indicated unknown to at least one of the first number of computing nodes, and the at least one of the first number of computing nodes meets a functionality requirement, send the block to the at least one of the first number of computing nodes.

11. The system of claim 7, wherein the designated computing node is designated by a method selected from the group consisting of round robin, a predetermined pseudorandom series, and a global perfect coin.

12. A system configured for block registration using a partially ordered data structure, and a distributed consensus protocol for communicating with a first number of computing nodes through a network, the system comprising:
at least one processing circuitry configured to:
accumulate a plurality of cryptographically signed blocks from a plurality of computing nodes from the first number of computing nodes, each block from the plurality of cryptographically signed blocks comprising a set of pointers to an additional block;
when each of the additional blocks to which a cryptographic hash pointer from the set of cryptographic hash pointers of each cryptographically signed block of the plurality of cryptographically signed blocks points, is accumulated or exists in the partially ordered data structure, add the cryptographically signed block to the partially ordered data structure; and
when a block generated by a designated computing node becomes finalized, starting with the block as the first block, to place in order, in an iterative or recursive manner, with most recent former block generated by the designated computing node of associated round and having an associated cryptographic hash pointer in the set of cryptographic hash pointers of a second number of blocks of a round following the associated round, acting as the second block and the first block for a next iteration, until the first block is in a fully ordered data structure, by adding each block reachable by a cryptographic hash pointer or iteratively following a set of cryptographic hash pointers of a block reachable by the cryptographic hash pointer, the cryptographic hash pointer existing in the set of cryptographic hash pointers of the first block but not in the set of cryptographic hash pointers of the second block, ordered by a deterministic topological-sorting method common to the first number of computing nodes, and prepended by the blocks produced by the next iteration, to the fully ordered data structure.

13. The system of claim 12, wherein a block becomes finalized when the block was generated by a designated node of a round, and at least the second number of the blocks of a second following round, comprising the block generated by the designated computing node of the second following round, have in each of a second associated set of cryptographic hash pointers, at least the second number of pointers pointing each to a block from a first following cycle, each have in a first associated set of cryptographic hash pointers, a cryptographic hash pointer pointing to the block, and the cryptographic hash pointer pointing to the block is the only cryptographic hash pointer, in the first associated set of cryptographic hash pointers, pointing to a block generated by the designated node of the round at the round.

14. The system of claim 12, wherein at least a second number is over two thirds of the first number.

15. A method for block registration using a partially ordered data structure, and a distributed consensus protocol for communicating with a first number of computing nodes through a network, the method comprising:
accumulate a plurality of cryptographically signed blocks from a plurality of computing nodes from the first number of computing nodes, each block from the plurality of cryptographically signed blocks comprising a set of pointers to an additional block;
when each of the additional blocks to which a cryptographic hash pointer from the set of cryptographic hash pointers of each cryptographically signed block of the plurality of cryptographically signed blocks points, is accumulated or exists in the partially ordered data structure, add the cryptographically signed block to the partially ordered data structure; and
when a block generated by a designated computing node becomes finalized, starting with the block as the first block, to place in order, in an iterative or recursive manner, with most recent former block generated by the designated computing node of associated round and having an associated cryptographic hash pointer in the set of cryptographic hash pointers of a second number of blocks of a round following the associated round, acting as the second block and the first block for a next iteration, until the first block is in a fully ordered data structure, by adding each block reachable by a cryptographic hash pointer or iteratively following a set of cryptographic hash pointers of a block reachable by the cryptographic hash pointer, the cryptographic hash pointer existing in the set of cryptographic hash pointers of the first block but not in the set of cryptographic hash pointers of the second block, ordered by a deterministic topological-sorting method common to the first number of computing nodes, and prepended by the blocks produced by the next iteration, to the fully ordered data structure.

16. A method for distributed consensus ordered block registration using a partially ordered data structure, and communicating with a first number of computing nodes through a network, the method comprising:
accumulate a plurality of cryptographically signed blocks from a plurality of computing nodes from the first number of computing nodes, each block from the plurality of cryptographically signed blocks comprising a set of cryptographic hash pointers, each cryptographic hash pointer pointing to an additional block;
execute a protocol adapted to synchrony specifications of the network on the plurality of cryptographically signed blocks using the network; and
generate a consecutive cryptographically signed block while adding to the block the set of cryptographic hash pointers, so that a path based on the set of cryptographic hash pointers exists to each of the plurality of cryptographically signed blocks.
